(19) United States
(12) Patent Application Publication
(10) Pub. No.: US 2024/0029377 A1
(43) Pub. Date: Jan. 25, 2024

(54) Devices, Methods, and Graphical User Interfaces for Providing Inputs in Three-Dimensional Environments

(71) Applicant: Apple Inc., Cupertino, CA (US)

(72) Inventors: Fiona P. O'Leary, Palo Alto, CA (US); Julian K. Missig, Burlingame, CA (US); Mark K. Hauenstein, Richmond (GB)

(21) Appl. No.: 18/222,958

(22) Filed: Jul. 17, 2023

Related U.S. Application Data
(60) Provisional application No. 63/469,789, filed on May 30, 2023.
(60) Provisional application No. 63/390,243, filed on Jul. 18, 2022.

(51) Int. Cl. G06T 19/20; G06T 19/00

(52) U.S. Cl. CPC G06T 19/20; G06T 19/006

(57) ABSTRACT

A computer system displays a three-dimensional environment and detects, via an input device that includes a first portion and a second portion that can be physically coupled in a first configuration and physically decoupled in a second configuration, a first input. In response to detecting the first input while the first portion is coupled to the second portion of the input device in the first configuration, the computer system performs a first operation in the three-dimensional environment. While the first portion of the input device and the second portion of the input device are decoupled in the second configuration, the computer system detects a sequence of one or more inputs that includes movement of the first portion of the input device relative to the second portion of the input device. In response to detecting the sequence of one or more inputs, the computer system performs one or more second operations.

### CROSS REFERENCE OF RELATED APPLICATIONS

This application claims priority to U.S. Application Ser. No. 63/469,789, filed May 30, 2023 and U.S. Application Ser. No. 63/390,243, filed Jul. 18, 2022, each of which is hereby incorporated by reference in its entirety.

### TECHNICAL FIELD

The present disclosure relates generally to computer systems that are in communication with a display generation component and one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics. A computer system may use cameras and handheld controllers to detect user inputs directed to the three-dimensional virtual and/or augmented reality environments displayed via a display generation component in communication with the computer system.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user by using a physical input device. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

A computer system that is in communication with one or more cameras, a display generation component, and an input device, wherein the input device includes a first portion of the input device and a second portion of the input device that are physically coupled in a first configuration and physically decoupled in a second configuration performs a method. The method includes displaying, via the display generation component, a three-dimensional environment that corresponds to a physical environment surrounding the input device, wherein displaying the three-dimensional environment includes displaying one or more virtual objects in the three-dimensional environment. The method includes, while displaying the three-dimensional environment, detecting, via the input device while the first portion of the input device is coupled to the second portion of the input device in the first configuration, a first input. The method includes, in response to detecting the first input while the first portion of the input device is coupled to the second portion of the input device in the first configuration, performing a first operation in the three-dimensional environment. The method further includes, while the first portion of the input device and the second portion of the input device are decoupled in the second configuration, detecting a sequence of one or more inputs that includes movement of the first portion of the input device relative to the second portion of the input device and in response to detecting the sequence of one or more inputs, performing one or more operations based on the sequence of one or more inputs that includes the movement of the first portion of the input device relative to the second portion of the input device, wherein the one or more operations are different from the first operation.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7N illustrate example techniques for performing operations in response to detecting a sequence of inputs with an input device, in accordance with some embodiments.

FIG. 8 is a flow diagram of methods of performing operations in response to detecting a sequence of inputs with an input device, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interactions, using an input device, with virtual/augmented reality environments in multiple ways.

In some embodiments, a computer system detects, via an input device that includes a first portion that is coupled to a second portion of the input device in a first configuration, a first input and performs a first operation in a three-dimensional environment. While the first portion of the input device and the second portion of the input device are decoupled in the second configuration, the computer system detects a sequence of one or more inputs that includes movement of the first portion of the input device relative to the second portion of the input device and performs one or more operations based on the sequence of one or more inputs, wherein the one or more operations are different from the first operation. The computer system thus allows the user with additional controls for interacting with an XR experience using an input device. The different manners by which the input device may be manipulated in the first, coupled configuration, and in the second, decoupled configuration provide a multitude of possibilities for controlling and interacting with an XR experience. The combinations of the manners that the input device are manipulated and corresponding operations that are performed in conjunction with one another and/or in sequence of one another, as disclosed herein, provide a more efficient human-machine interface interfaces, e.g., by reducing the number, extent, and/or the nature of the inputs from a user, and by providing useful and intuitive visual feedback that helps to reduced mistakes and intellectual burden placed on the user. In some embodiments, the input device may be attached to the computer system and/or placed in a configuration (e.g., in a coupled configuration, in an uncoupled configuration, coupled to a charging device as two decoupled portions charging via separate charging connections to the charging device, or coupled to a charging device via a single charging connection in a coupled configuration) that enables charging of the computer system and/or different portions of the input device more efficiently and/or quickly, which may extend the usage time and reduce down time due to depletion of power.

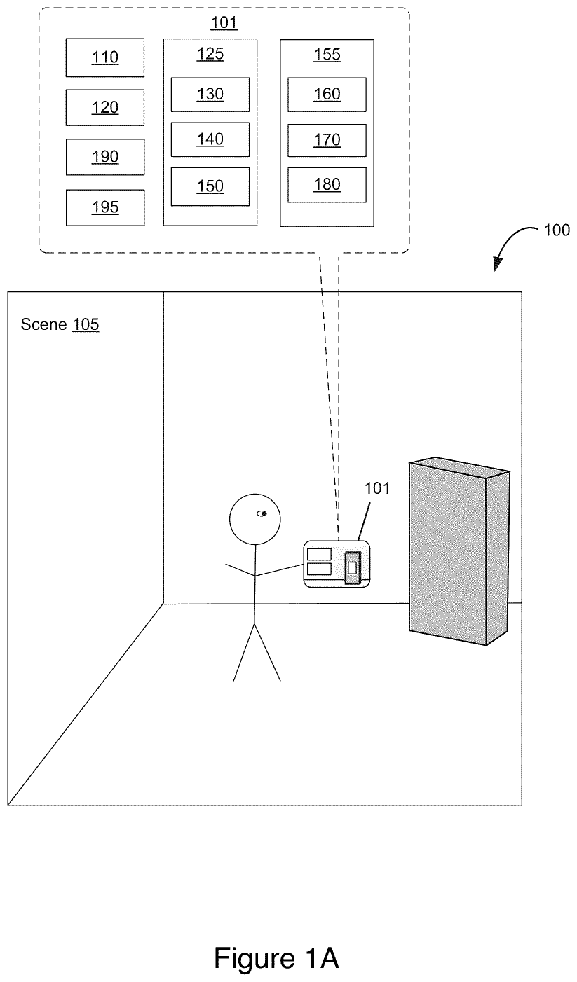

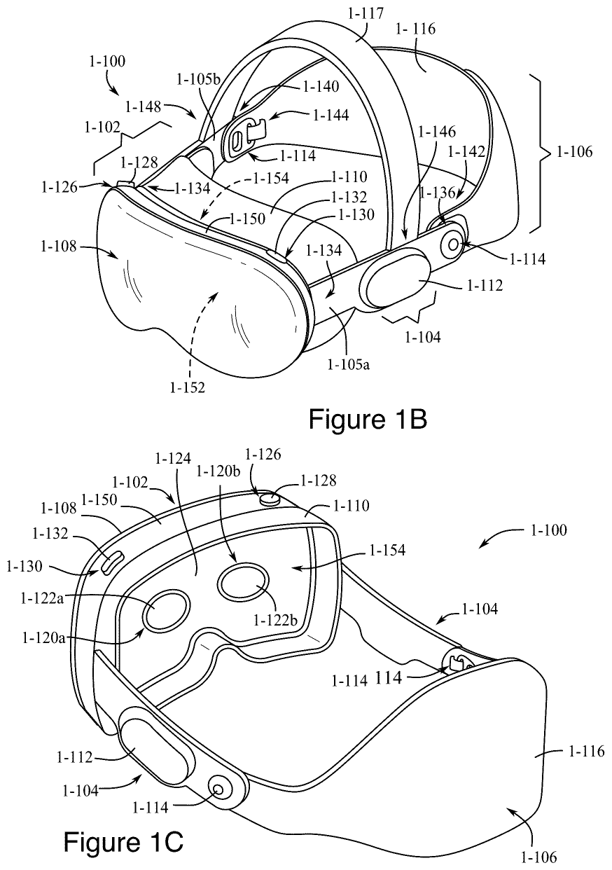

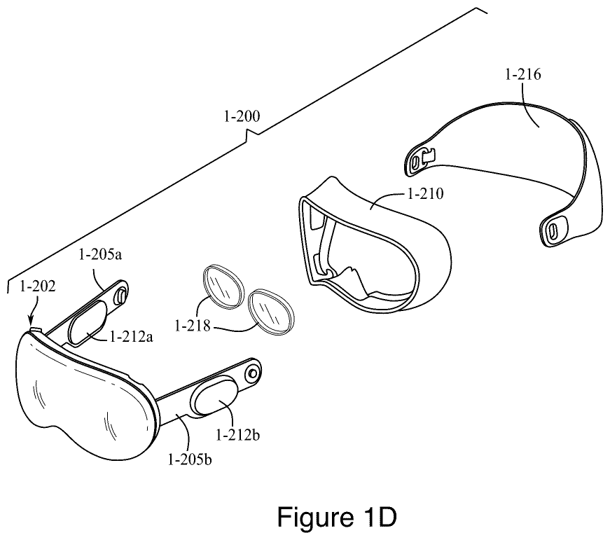

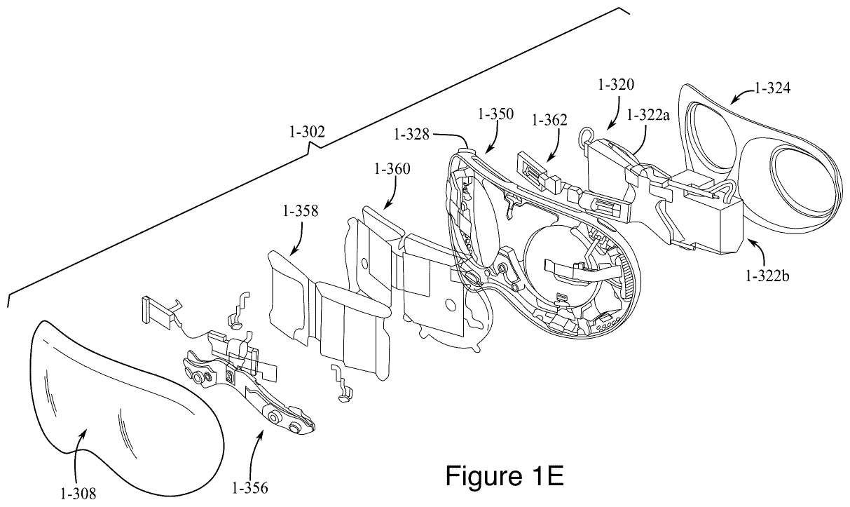

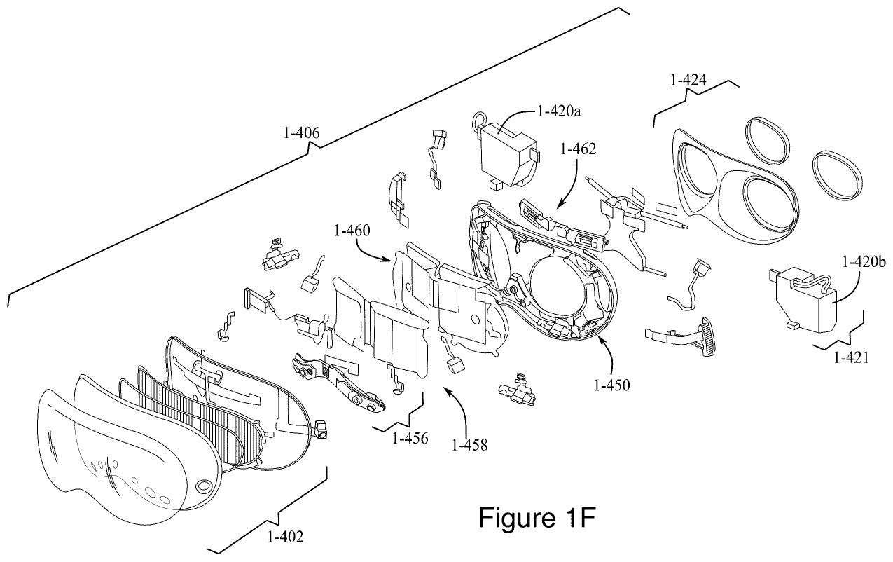

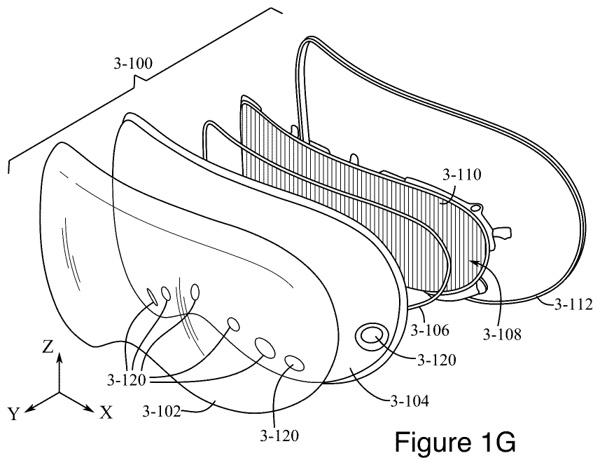

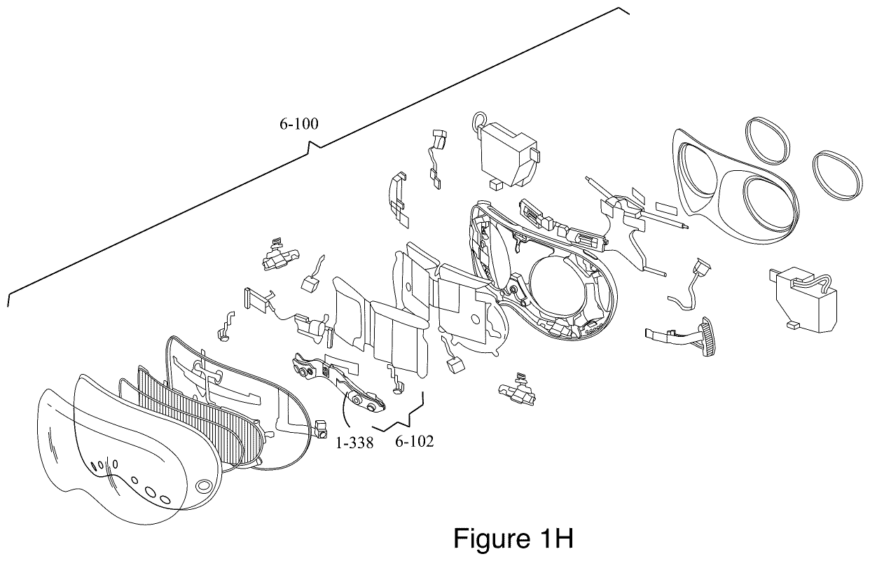

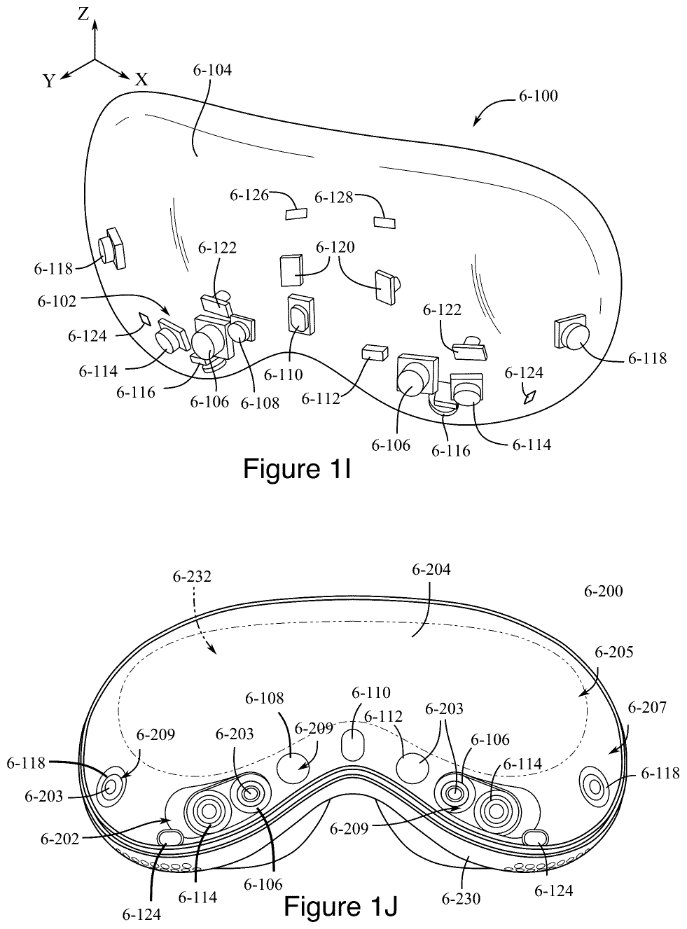

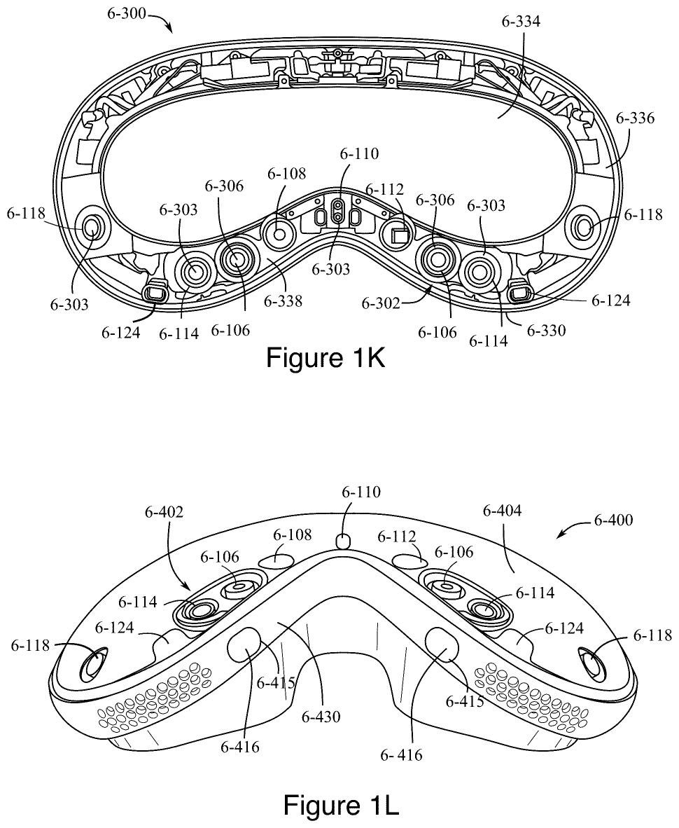

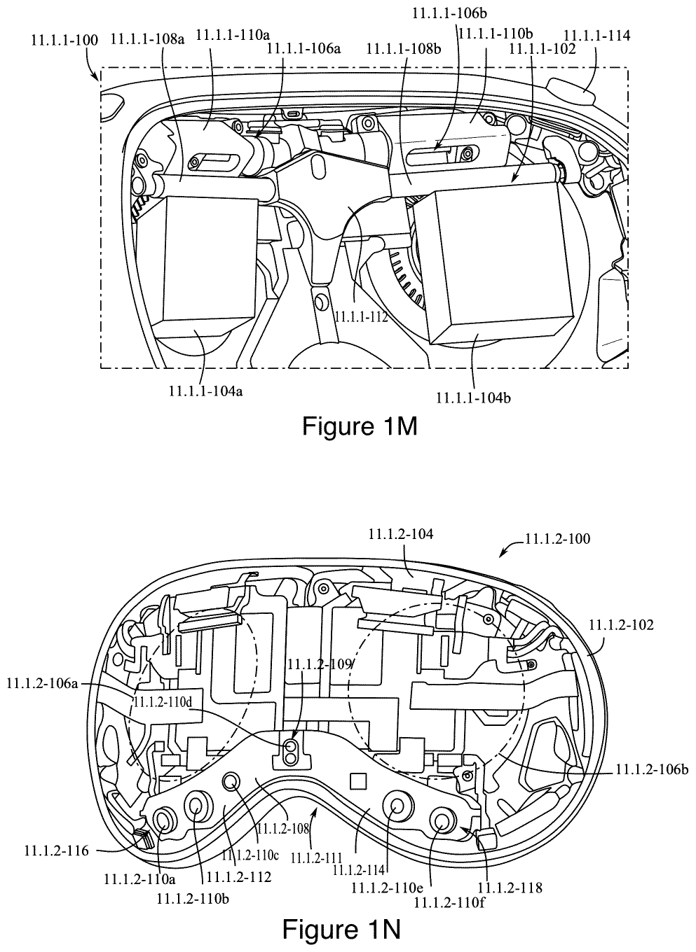

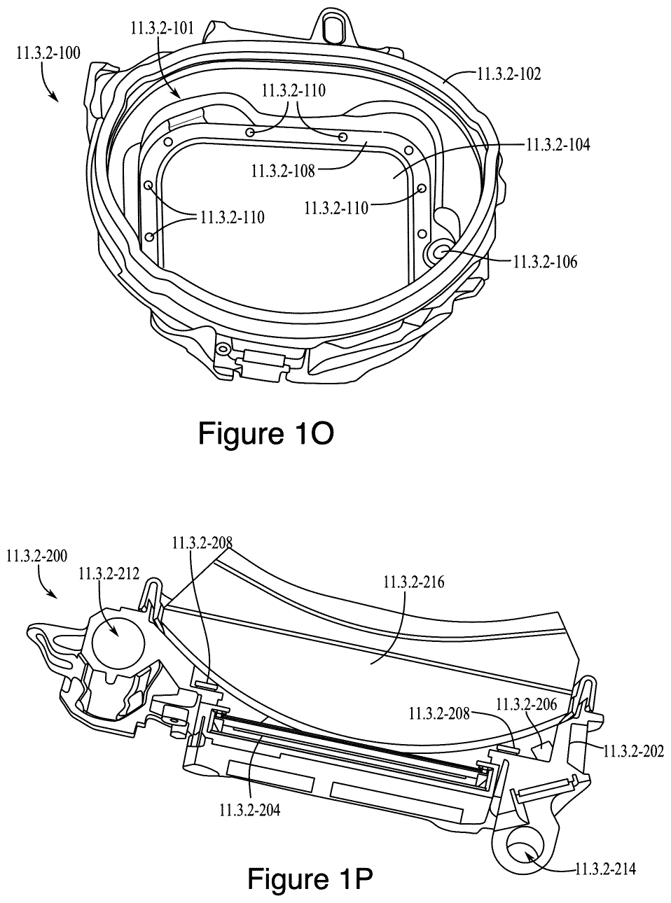

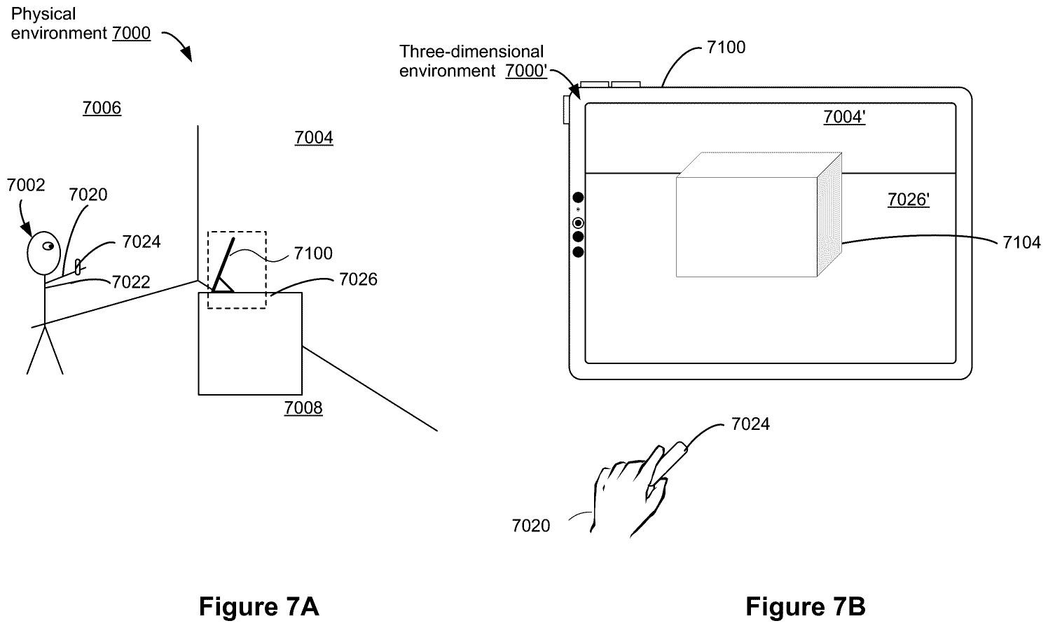

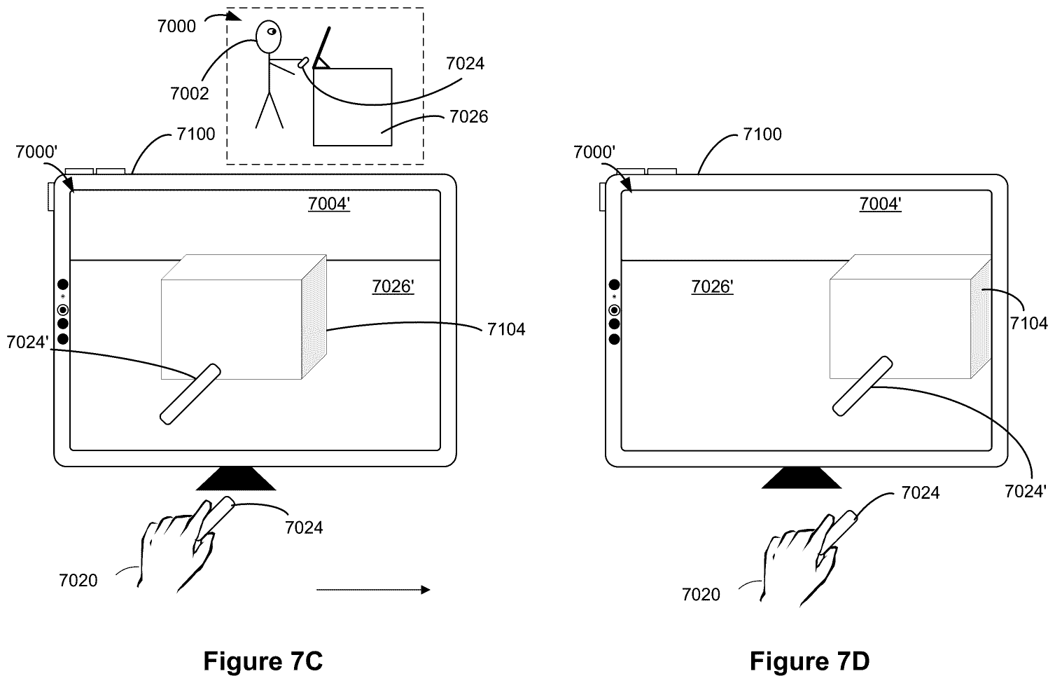

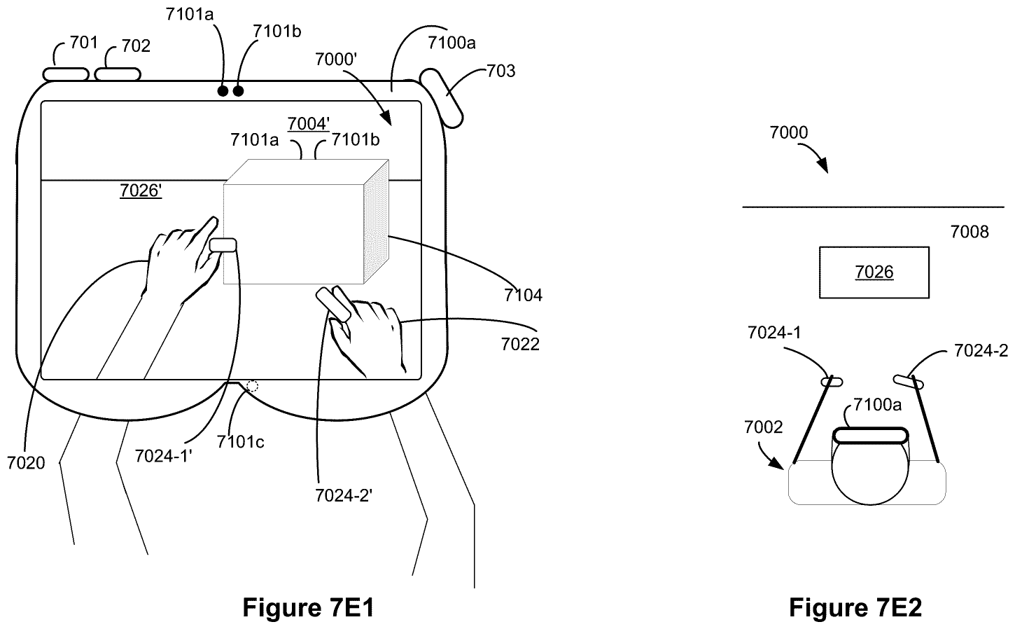

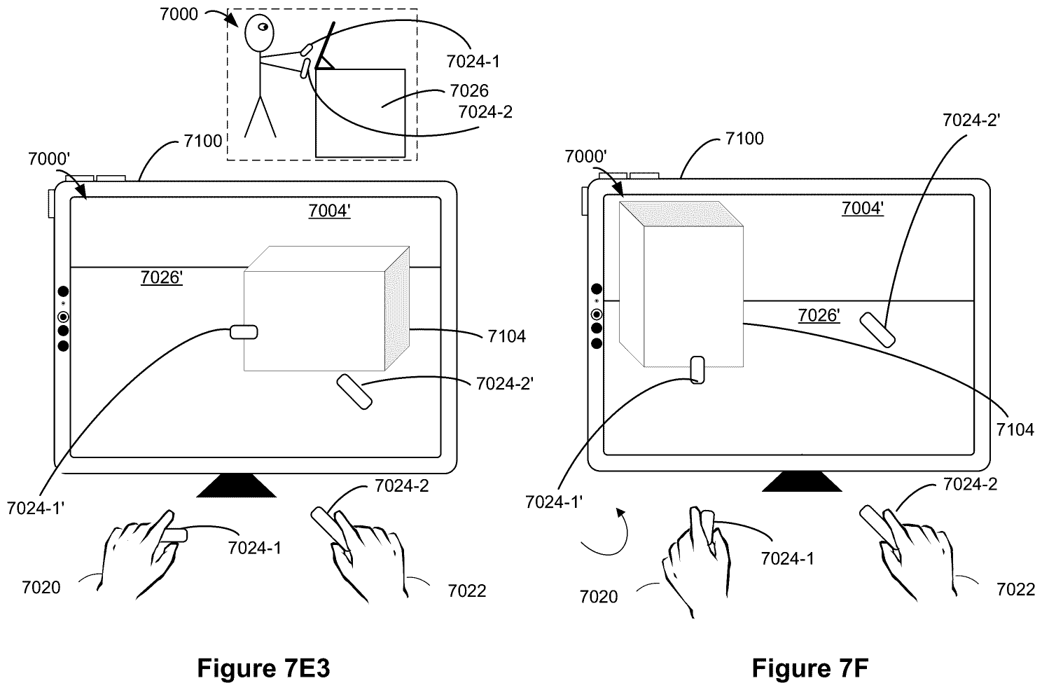

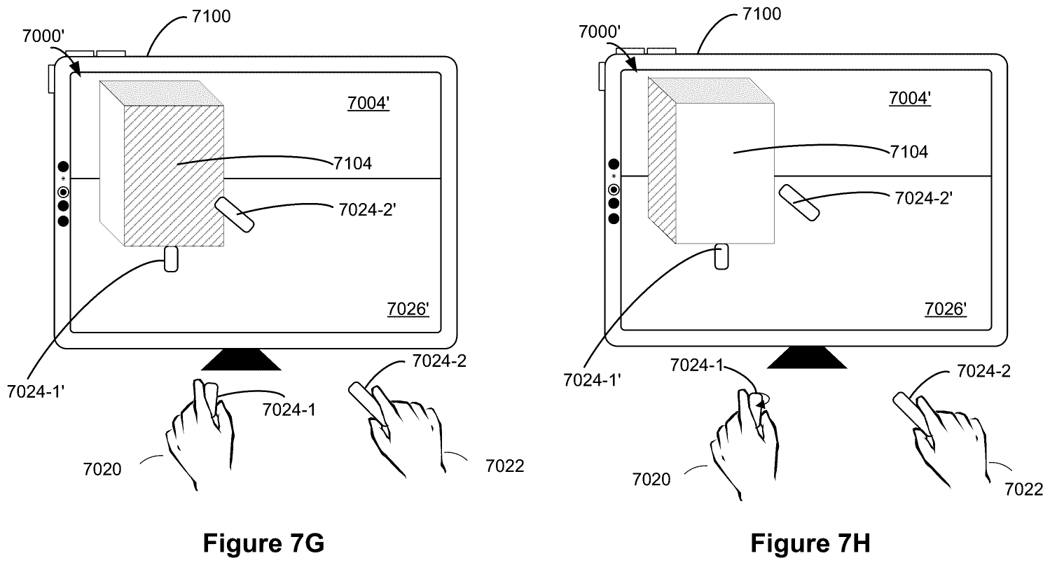

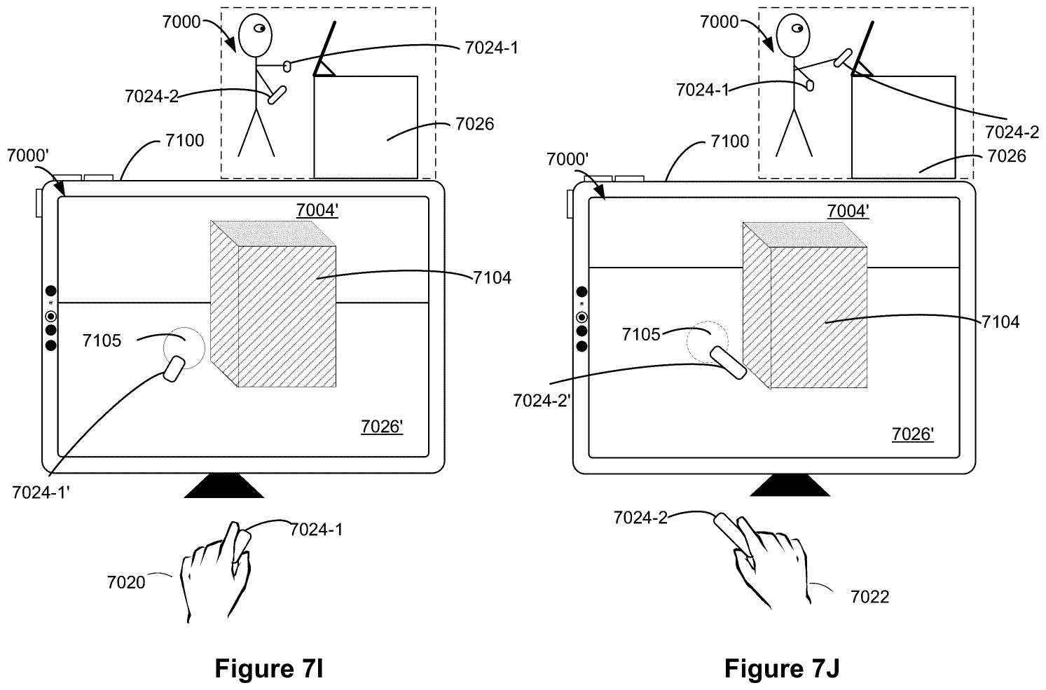

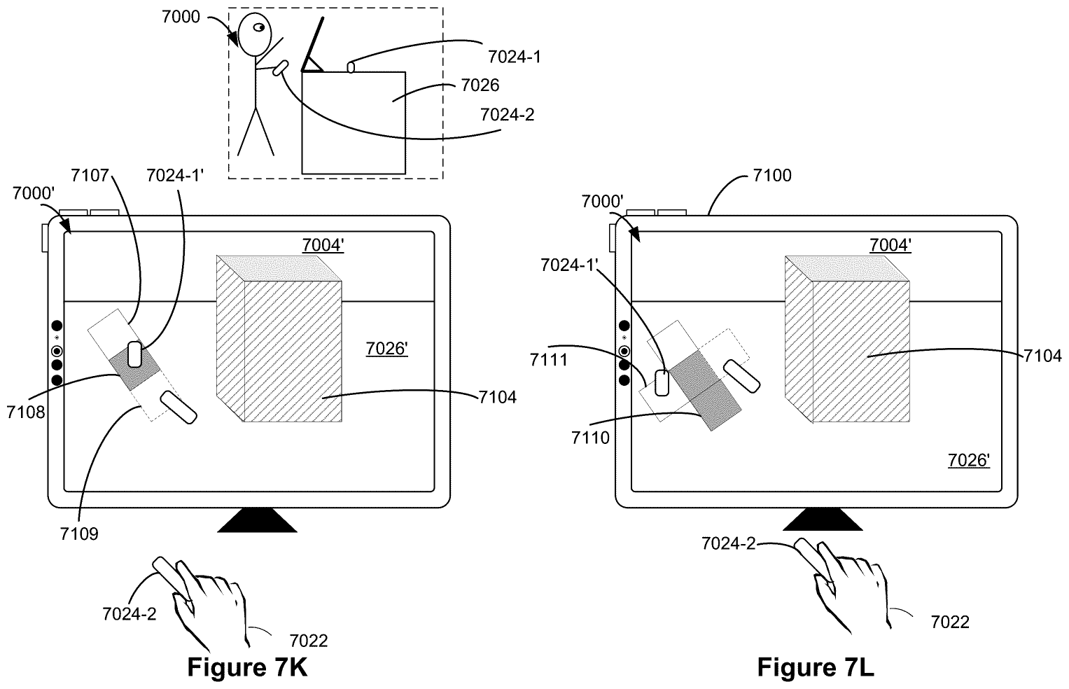

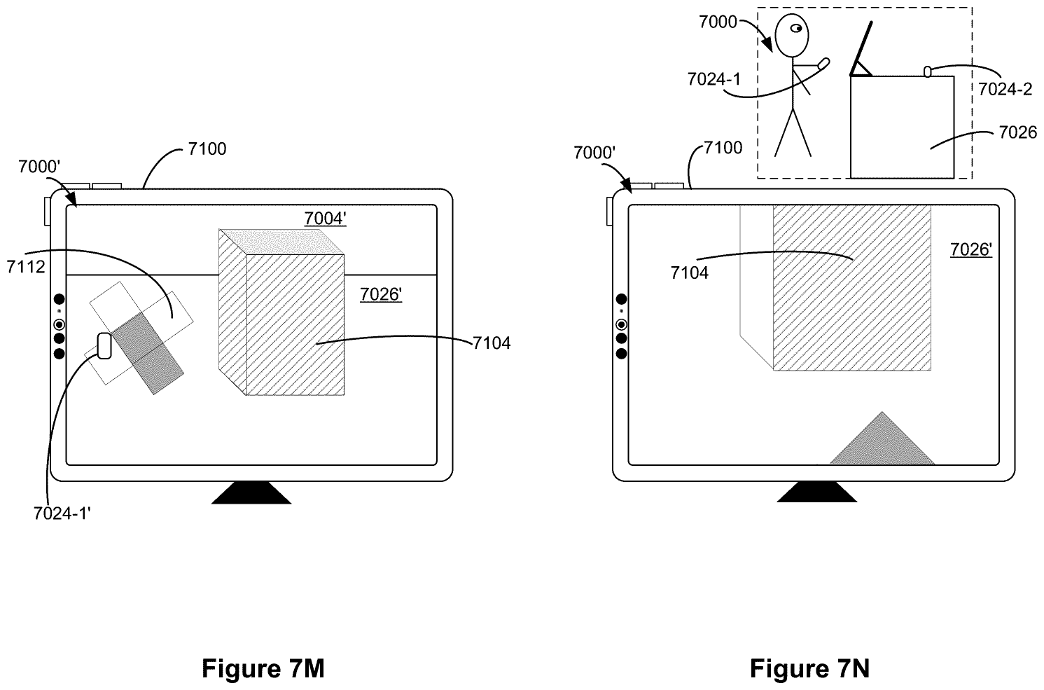

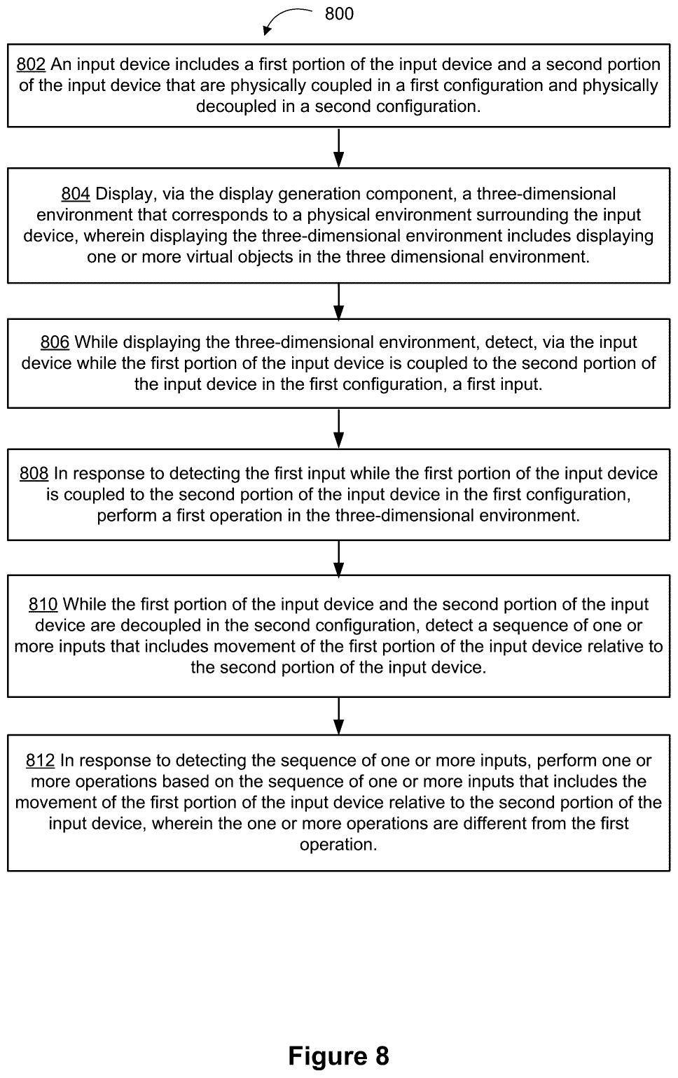

FIGS. 1A-6 provide a description of example computer systems for providing XR experiences to users. FIGS. 7A-7N illustrate example techniques for performing operations in response to detecting a sequence of inputs with an input device, in accordance with some embodiments. FIG. 8 is a flow diagram of methods of performing operations in response to detecting a sequence of inputs with an input device, in accordance with various embodiments. The user interfaces in FIGS. 7A-7N are used to illustrate the process shown in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (TIMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

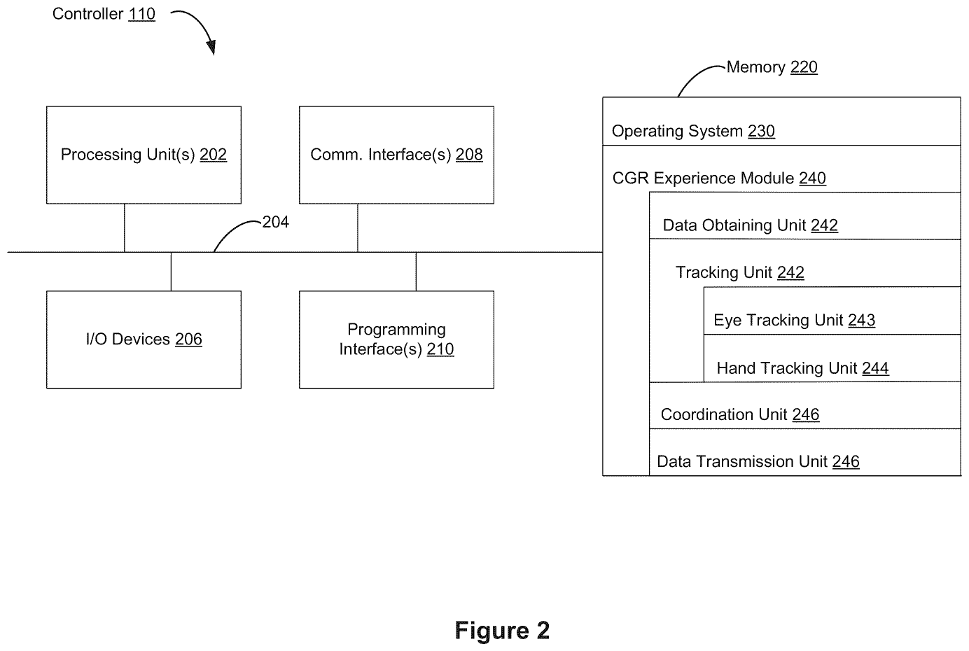

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

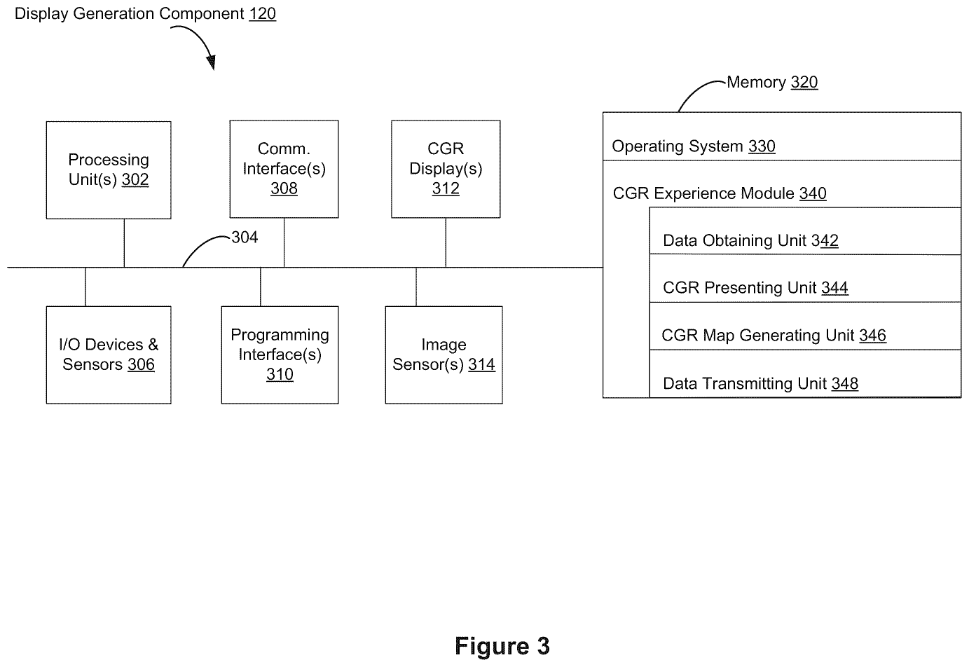

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the MD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the MD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

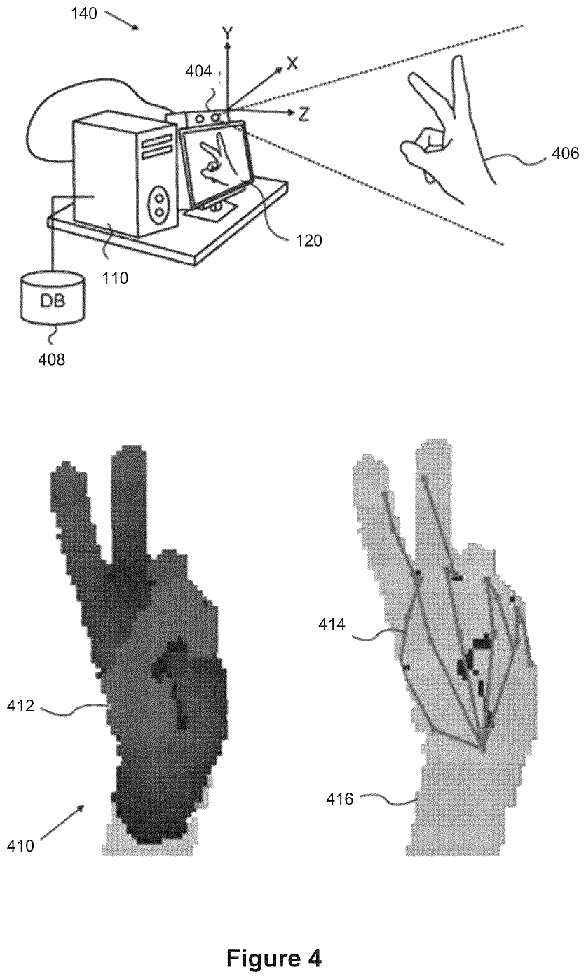

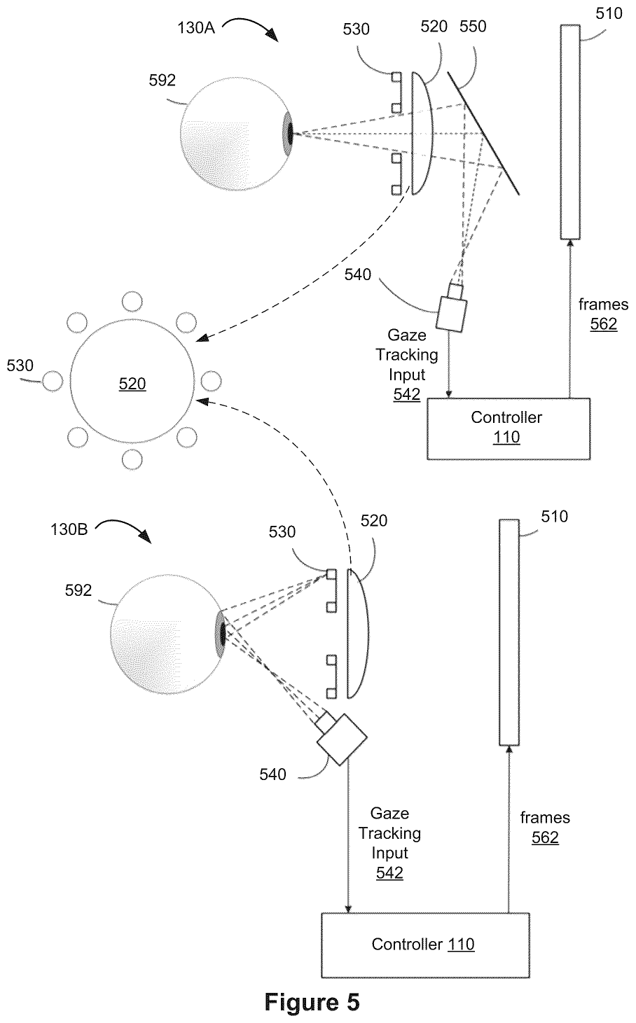

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands)

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and a light source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

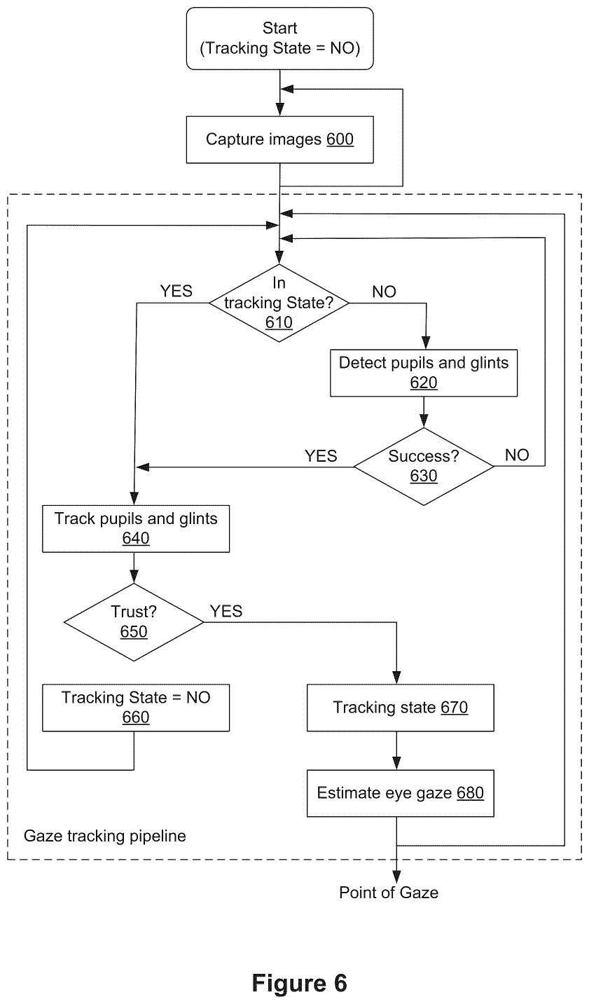

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component, one or more input devices, and optionally one or more cameras.

FIGS. 7A-7N include illustrations of three-dimensional environments that are visible via a display generation component (e.g., a display generation component 120) and interactions that occur in the three-dimensional environments caused by user inputs directed to the three-dimensional environments and/or inputs received from other computer systems and/or sensors. In some embodiments, a computer system detects an input that is directed to a virtual object within a three-dimensional environment by detecting a user's gaze directed to the region occupied by the virtual object, or by detecting a hand gesture performed at a location in the physical environment that corresponds to the region of the virtual object in the three-dimensional environment displayed via the display generation component. In some embodiments, the computer system detects an input that is directed to a virtual object within a three-dimensional environment by detecting a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, the computer system detects an input that is directed to a virtual object within a three-dimensional environment through an input device (e.g., input device 7024, or another input device in communication with the computer system) that has positioned a focus selector object (e.g., a pointer object, selector object, or other indication of a portion of the user interface that the user is interacting with) at the position of the virtual object in accordance movement and/or manipulation of the input device by a user. In some embodiments, the computer system detects an input that is directed to a virtual object within a three-dimensional environment via other means (e.g., voice, control button, or other input). In some embodiments, the computer system detects an input that is directed to a representation of a physical object or a virtual object that corresponds to a physical object by detecting the user's hand movement (e.g., whole hand movement, whole hand movement in a respective posture, movement of one portion of the user's hand relative to another portion of the hand, relative movement between two hands, or other hand input) and/or manipulation with respect to the physical object (e.g., touching, swiping, tapping, opening, moving toward, moving relative to, or other manipulation). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detects movement of other persons and objects and movement of the user that may not quality as a recognized gesture input for triggering an associated operation of the computer system. In some embodiments, the computer system transitions between different levels of immersion by adjusting the relative prominence of audio/visual sensory inputs from the virtual content and from the representation of the physical environment. For example, in some embodiments, when the computer system displays a three-dimensional environment at a lower level of immersion, the computer system reduces the amount of virtual content (e.g., removing overlays on walls and windows, removing virtual scenes, and/or reducing area covered by virtual textures) and/or changes the visual properties of the virtual content (e.g., reducing luminance, reducing color saturation, reducing opacity, and/or increasing translucency) such that the virtual content becomes less visually prominent and/or reveals more of the visual properties (e.g., shape, color, structure, compositions, and/or appearances) of the surrounding physical environment in the three-dimensional environment, as compared to the three-dimensional environment displayed with a higher level of immersion. In some embodiments, when the computer system displays a three-dimensional environment at a higher level of immersion, the computer system increases the amount of virtual content (e.g., adding overlays on walls and windows, displaying virtual scenes, and/or increasing area covered by virtual textures) and/or block out the visual properties (e.g., shape, color, structure, compositions, and/or appearances) of the surrounding physical environment by changing the visual properties of the virtual content (e.g., increasing luminance, increasing color saturation, increasing opacity, and/or reducing translucency) such that the virtual content becomes more visually prominent relative to the visual properties (e.g., shape, color, structure, compositions, and/or appearances) of the surrounding physical environment in the three-dimensional environment, as compared to the three-dimensional environment displayed with a lower level of immersion. In some embodiments, when increasing the level of immersion of the three-dimensional environment, the computer system uses various audio processing methods to filter out sounds from the physical environment, so that the user receives less auditory sensors signals from the physical environment when viewing and listening to the computer-generated visual and audio content.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, and/or adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is visible. In some embodiments, the pass-through portion of the display generation component is a transparent or semi-transparent (e.g., see-through) portion of the display generation component revealing at least a portion of a physical environment surrounding and within the field of view of user. For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint, optionally, with or without a lazy follow behavior), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment (optionally, with or without a lazy follow behavior). In some embodiments, a virtual object is locked (optionally, with or without a lazy follow behavior) to a preset portion of a field of view provided by the display generation component and moves in the three-dimensional environment in accordance with the movement of the field of view, irrespective of movement of the user that does not cause a change of the field of view.

In some embodiments, as shown in FIGS. 7A-7N, the views of a three-dimensional environment sometimes do not include representation(s) of a user's hand(s), arm(s), and/or wrist(s) and/or representation(s) of one or more input devices. In some embodiments, the representation(s) of a user's hand(s), arm(s), and/or wrist(s) and/or representation(s) of one or more input devices are included in the views of a three-dimensional environment. In some embodiments, the representation(s) of a user's hand(s), arm(s), and/or wrist(s) and/or the representation(s) of one or more input devices are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s) and/or the input device(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) and/or input device(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands and/or input devices of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist and/or input device is outside of the currently displayed view of the three-dimensional environment while the virtual position in the three-dimensional environment that corresponds to the location of the user's hand or wrist and/or input device is outside of the current field of view provided via the display generation component; and the representation of the user's hand or wrist and/or input device is made visible in the view of the three-dimensional environment in response to the virtual position that corresponds to the location of the user's hand or wrist and/or input device being moved within the current field of view due to movement of the display generation component, the user's hand or wrist and/or input device, the user's head, and/or the user as a whole.

FIGS. 7A-7N illustrate examples of an input device performing various operations in a three-dimensional environment. FIG. 8 is a flow diagram of an exemplary method 800 for an input device performing various operations in a three-dimensional environment. The user interfaces in FIGS. 7A-7N are used to illustrate the processes described below, including the processes in FIG. 8.

FIG. 7A illustrates a physical environment 7000, which includes a first wall 7004, a second wall 7006 and a floor 7008. In some embodiments, a user 7002 is in the physical environment 7000. In some embodiments, the user 7002 has a first arm with a first hand 7020 (e.g., a left hand) and a second arm with a second hand 7022 (e.g., a right hand). In some embodiments, the first hand 7020 holds an input device 7024. In some embodiments, the input device 7024 is an elongated object (e.g., shaped like a marker, a wand, or a block). In some embodiments, the input device 7024 is configured to split into two or more distinct portions, as described in more detail below.

Physical environment 7000 further includes a physical object 7026. In some embodiments, the physical object 7026 includes at least one surface (e.g., a horizontal surface parallel to floor 7008). For example, the physical object 7026 includes a table, a box, or another physical object on which physical items may be placed.

In some embodiments, physical environment 7000 includes a computer system 7100 that includes a display generation component, and one or more cameras. In some embodiments, user 7002 uses input device 7024 to interact with (e.g., control and/or manipulate) the computer system 7100 and the three-dimensional environment generated/displayed by the computer system 7100. In some embodiments, the computer system supports user interaction by user 7002 via other means (e.g., air gestures and touch inputs, as described above) that may not require input device 7024. In some embodiments, computer system 7100 detects a current position of input device 7024 via one or more sensors of computer system 7100. For example, one or more cameras of computer system 7100 and/or one or more magnetometers of computer system 7100 track movements of the input device 7024. In some embodiments, the one or more magnetometers of computer system 7100 determine changes in a magnetic field surrounding the input device 7024 (e.g., different portions of input device 7024 include respective magnets that may alter the magnetic field near the different portions of the input device).

In some embodiments, input device 7024 includes at least a first portion 7024-1 and a second portion 7024-2 that are physically coupled together at a first point of physical contact with each other, where the first portion 7024-1 and the second portion 7024-2 are configurated such that a user may be able to break (e.g., by bending, twisting, clicking, and/or pulling apart the input device at the first point of physical contact, and/or opening, disabling, disengaging a physical connection at) the first point of physical contact and decouple the first portion and the second portion of the input device from physical contact with each other. In some embodiments, when the first portion and the second portion of the input device 7024 are physically coupled in the first configuration, the entirety of the input device 7024 moves as an integrated whole, irrespective of which portion of the input device 7024 is being held and moved by the user. For example, the computer system detects movement of the input device 7024 in various manners, such as rotating around a longitudinal axis of the input device 7024, rotating around a pivot point at a first position along the body of the input device 7024, moving horizontally when an upright/supine attitude or posture, moving vertically when an upright/supine attitude or posture, and/or moving around a pivot or axis that is outside of the body of the input device), moving in a respective direction with the elongated body of the input device substantially aligned with the respective direction, moving in a respective direction with the elongated body of the input device transverse to the respective direction. In some embodiments, the computer system does not differentiate between the first portion or the second portion (e.g., whether the first portion leads and the second portion follows, or whether the second portion leads and the first portion follows) during the movement of the input device. In some embodiments, the computer system provides differentiated responses depending on whether the first portion or the second portion of the computer system leads the movement of the input device as a whole. In some embodiments, when the first portion and the second portion of the input device 7024 has been physically decoupled from each other, the first portion and the second portion are able to be moved relative to each other in accordance with user's manipulation of either or both of the first and second portions of the input device 7024. For example, the computer system detects rotational movement of the first portion around the second portion of the input device (e.g., while the second portion is kept stationary at a respective position or is moving in a respective manner), or vice versa. In some embodiments, the computer system detects translational movement of the first portion relative to the second portion of the input device (e.g., while the second portion is kept stationary at a respective position or is moving in a respective manner), or vice versa. In some embodiments, the computer system detects the respective positions and/or attitudes or postures of the first and second portions of the input device while the first portion and the second portion of the input device are kept stationary and/or moving according to user's manipulation. In some embodiments, the computer system detects rotation of the first portion and/or the second portion of the input device around their respective longitudinal axes, respective internal pivot points, and/or axes and/or pivot points outside of the first portion and second portion of the input device. In some embodiments, the input device includes touch-sensitive surfaces and/or other sensors (e.g., motion sensors, attitude sensors, and/or light sensors) that detect touch locations touch durations and/or movement of contacts on the surface(s) of the first portion and/or second portion of the input device. 7024. In some embodiments, the computer system detects different touch gestures (e.g., tap, tap-hold, swipe, and/or flick) and/or air gestures (e.g., air tap, air flick, air swipe, and/or air pinch) by evaluating position and/or movement of the first portion and/or second portion of the input device against preset criteria corresponding to the different touch gestures and/or air gestures. In some embodiments, the input device optionally includes one or more buttons and/or switches on the first portion and/or the second portion of the input device. In some embodiments, the computer system detects the respective position, attitudes/postures, and/or orientations of the first portion and the second portion and the input device, the relative position, orientation, and/or spatial relationship between the first portion and the second portion of the input device, and/or the coupled/decoupled state of the first portion and the second portion of the input device, during movement of the first portion and/or second portion of the input device and while the first portion and/or second portion of the input device is kept stationary. In some embodiments, the first portion and the second portion of the input device are physically coupled to each other at a first physical point of contact to form a first configuration (e.g., connected to form a linear object, and/or connected with the first portion covering a part of the second portion (e.g., like a pen cap on pen tip)). In some embodiments, the first portion and the second portion of the input device are optionally coupled to each other at a second physical point of contact and/or form a different configuration (e.g., connected to form an angle, nested and/or telescoped out). In some embodiments, any combinations of one or more the inputs and states of the first portion, the second portion, and the integrated whole of the input device described above and later in this disclosure are optionally detected by the computer system and the computer system provides corresponding responses (e.g., changing the content of the three-dimensional environment, performing operations, and/or changing the states of the computer system, content, and/or objects) according to the detected inputs. More details of the use of the input device 7024 are provided with respect to FIGS. 7A-7N and FIG. 8 and accompanying descriptions.

In some embodiments, the one or more cameras of the computer system capture portions of physical environment 7000, and the computer system displays a representation of the portion of the physical environment 7000 that is within a field of view of the one or more cameras. For example, as illustrated in FIG. 7B, a representation of the three-dimensional environment 7000′ (e.g., that corresponds to physical environment 7000) is displayed by computer system 7100. In some embodiments, the representation of the three-dimensional environment 7000′ includes a representation of the first wall 7004′ that corresponds to the physical first wall 7004, and a representation of a surface of the physical object 7026′ that corresponds to physical object 7026. In some embodiments, the three-dimensional environment 7000′ is an XR-environment. For example, in some embodiments, the representation of the first wall 7004′ and the representation of the surface of the physical object 7026′ are virtual representations generated by the computer system (e.g., displayed in a VR environment, and/or in an AR environment). In some embodiments, the representation of the first wall 7004′ and the representation of the surface of the physical object 7026′ are displayed as pass-through views of physical objects in an AR environment.

In some embodiments, as illustrated in FIG. 7B, a virtual object 7104 is displayed by computer system 7100 in the three-dimensional environment (e.g., at a position that corresponds to a surface of physical object 7026). In some embodiments, the computer system adds virtual object 7104 to the three-dimensional environment in response to detecting a user selecting from a set of predefined virtual objects, and/or drawing, or otherwise inputting, the virtual object 7104. In some embodiments, the first hand 7020 of the user 7002 holds the input device 7024. In some embodiments, the computer system places the virtual object 7104 at a position in the three-dimensional environment in accordance with an input provided via the input device 7024 (e.g., a tap by the input device 7104 on the surface of the physical object 7026 at a desired location, or another input by the input device 7104 (e.g., a flick, or an air tap) while the user's gaze is directed to the desired location on the surface of the representation 7026′). In some embodiments, the virtual object 7104 is already displayed in the three-dimensional environment (e.g., by the computer system and/or in response to prior user inputs), and the computer system detects a request to shift input focus onto the virtual object 7104 in response to detecting a preset input by the input device (e.g., tapping a tip of the input device (e.g., the first portion of the input device, the second portion of the input device, or any part of the input device) at a physical location that corresponds to the position of the virtual object 7104 in the three-dimensional environment, or performing a preset air gesture using the input device while a gaze is detected on the virtual object 7104). In some embodiments, the computer system detects that the input device is in the first configuration with the first portion and the second portion of the input device physically coupled at the first point of contact between the first portion and the second portion of the input device, while detecting the position and movement of the input device 7024.

FIG. 7C illustrates a position of the user 7002 within the physical environment 7000. For example, in some embodiments, the user operates the input device 7024 while the user is in front of and facing toward the computer system 7100. In some embodiments, the computer system 7100 is a head-mounted display (HMD), heads-up display (HUD), or other computer system situated on the user's head and/or attached to the user's face that includes a display generation component for displaying the XR environment for the user. In such instances, the computer system may be situated between the user (e.g., the user's head and/or eyes) and the input device 7024. For example, while wearing an HMD, the user's hands are free to maneuver the input device 7024 (e.g., while the input device 7024 is within the portion of the physical environment that is captured in the field of view provided by the display generation component).

FIGS. 7C-7D further illustrate the user interacting with the computer system 7100 from the perspective of the user 7002 that is viewing the three-dimensional environment from a first viewpoint that corresponds to a position and/or attitude of a display generation component of the computer system 7100.

FIGS. 7C-7D illustrate a process for moving the virtual object 7104 from a first position to a second position in the three-dimensional environment using input device 7024, in accordance with some embodiments. For example, while the virtual object 7104 is selected (e.g., in response to detecting a press input on a button of input device 7024 while the input device 7024 is positioned at a location that corresponds to the virtual object 7104, or in response to detecting a tap input performed using input device 7024 at a location corresponding to the virtual object 7104), the computer system detects movement of the input device 7024 to the right as a whole; and in response to detecting the movement of the input device as a whole, the computer system moves the virtual object 7104 to the right. In some embodiments, the movement of the virtual object is contemporaneous with and follows the path of the movement of the input device (e.g., the virtual object is dragged by the input device). In some embodiments, a direction and/or amount of movement of the virtual object 7104 is determined in accordance with (e.g., proportionally to, or equally to) a direction and/or amount of movement of the input device 7024. In some embodiments, a position of input device 7024 is determined using one or more sensors, including one or more magnetometers, one or more cameras, and/or one or more IR sensors. In some embodiments, the movement of the virtual object is confined to the surface of the representation 7026′ of the physical object 7026, and only movement of the input device 7024 in a direction aligned with the surface of the physical object 7026 is used to determine the movement of the virtual object 7104. In some embodiments, the movement of the virtual object is not restrained, and the virtual object 7104 moves (e.g., translates) freely in three dimensions in accordance with the movement of the input device in the physical environment. In some embodiments, the virtual object maintains its orientation and attitude/posture in the three-dimensional environment, irrespective of the movement of input device 7024 as a whole in the physical environment (e.g., translation, and/or rotation around its longitudinal axis, an external axis, and/or an internal or external pivotal point).

In some embodiments, a representation of the input device 7024′ is displayed in the representation of the three-dimensional environment 7000′. In some embodiments, the representation of the input device 7024′ and/or the representation of physical object 7026′ are pass-through views of the physical objects (e.g., as described with reference to FIG. 7K). In some embodiments, the representation of the input device 7024′ is a virtual object that is generated by the computer system (e.g., in accordance with the shape, size, position, and/or attitude/posture of the input device 7024 in the physical environment). In some embodiments, the display of the representation of the input device 7024′ in the three-dimensional environment 7000′ is updated in accordance with the movement (e.g., rotation, and/or translation) of the input device 7024 in the physical environment 7000. In some embodiments, the representation of the input device 7024′ is not displayed or is displayed in accordance with one or more conditions being satisfied. For example, the representation of the input device 7024′ is not displayed until the input device is detected at a position for selecting an object or an object has been selected. In some embodiments, the computer system detects that the input device 7024 has been separated into its individual portions, e.g., the first portion 7024-1 and the second portion 7024-2. In some embodiments, the computer system detects that the first portion and the second portion of the input device 7024 are physically decoupled from each other and are no longer connected at the first point of physical contact that previously joined the two portions of the input device. In some embodiments, the computer system detects that the first point of physical contact ceases to exist based on one or more sensors (e.g., contact sensors, distance sensors, and/or electrical, capacitive, and/or light sensors) existing in the first portion and/or the second portion of the input device 7024. In this illustrative example, the computer system detects that the user holds the portions of the input device 7024 in different hands (e.g., first hand 7020 holds the first portion 7024-1 and second hand 7022 holds the second portion 7024-2), as shown in FIGS. 7E1, 7E2 and 7E3 (e.g., “FIGS. 7E”).

In some embodiments, the computer system 7100 comprises a head mounted display (HMD) 7100a. For example, as illustrated in FIG. 7E1, the head mounted display 7100a includes one or more displays that display a representation of a portion of the three-dimensional environment 7000′ that corresponds to the perspective of the user, while an HMD typically includes multiple displays including a display for a right eye and a separate display for a left eye that display slightly different images to generate user interfaces with stereoscopic depth, in the figures a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments input elements are mechanical input elements, in some embodiments input elements are solid state input elements that respond to press inputs based on detected pressure or intensity. For example, in FIG. 7E1 HMD 7100a includes one or more of button 701, button 702 and digital crown 703 for providing inputs to HMD 7100a. It will be understood that additional and/or alternative input devices may be included in HMD 7100a.

FIG. 7E1 illustrates the first portion 7024-1 and the second portion 7024-2 of the input device 7024 that are held in the different hands of the user. In some embodiments, the hands of the user are located, in the physical environment 7000, on the other side, relative to the user's viewpoint, of the display of HMD 7100a. For example, HMD 7100a is closer to the user's eyes than the user's hands, which are, from the perspective of the user, located behind the display of HMD 7100a. In some embodiments, representations of the hands of the user are optionally displayed in the portion of the three-dimensional environment 7000′ (e.g., the representations of the user's hands are displayed as passthrough objects or as virtual representations). In some embodiments, the representations of the user's hands are not displayed in the portion of the three-dimensional environment 7000′, while a representation 7024-1′ of the first portion of the input device and a representation 7024-2′ of the second portion of the input device are displayed.

FIG. 7E1 further illustrates a selection of the virtual object 7104 (e.g., in response to detecting a press input on a button of the first portion of the input device 7024 (e.g., same as the button on the input device previously used to select the virtual object 7104 in the process shown in FIGS. 7C-7D, or a different button) while the first portion of the input device 7024 is positioned at a location that corresponds to the virtual object 7104, or in response to detecting a tap input performed using the first portion of the input device 7024-1 at a location corresponding to the virtual object 7104). For example, in response to the selection of the virtual object 7104, the computer system (e.g., HMD 7100a or computer system 7100) establishes a fixed or substantially fixed spatial relationship between the representation 7024-1′ of the first portion of the input device and the virtual object 7104 in the three-dimensional environment, such that the first portion of the input device 7024-1 may be used as a “handle” of the virtual object to spatially move and rotate the virtual object. In some embodiments, HMD 7100a performs a sequence of operations in response to inputs detected by the input device 7024, as described with reference to FIGS. 7E1-7N.

FIG. 7E2 illustrates a top-down view of the user 7002 in the physical environment 7000. For example, the user 7002 is wearing HMD 7100a, such that the input device portions 7024-1 and 7024-2 are physically present within the physical environment 7000 behind the display of HMD 7100a, and optionally in front of the physical object 7026 (e.g., where virtual object 7104 is displayed on top of a surface of physical object 7026).

FIG. 7E1 illustrates an alternative display of the computer system than the display illustrated in FIGS. 7A-7D and 7E3-7N. It will be understood that the processes, features and functions described herein with reference to the computer system 7100 described in FIGS. 7A-7D and 7E3-7N are also applicable to HMD 7100a, illustrated in FIG. 7E1.

As described above with reference to FIG. 7C, FIG. 7E illustrate a perspective of the user 7002 within the physical environment 7000 holding the first portion 7024-1 of the input device in the left hand and the second portion 7024-2 of the input device in the right hand. FIGS. 7E-7F further illustrate the user interacting with the computer system 7100 from the perspective of the user 7002 that is viewing the three-dimensional environment from the first viewpoint that corresponds to a position and/or attitude of a display generation component of the computer system 7100. In some embodiments, the process shown in FIGS. 7E-7F optionally occurs before the process shown in FIGS. 7C-7D, or after the process shown in FIGS. 7C-7D (e.g., the computer system determines how to manipulate the virtual object based on the coupled/decoupled state of the input device and the movement of the portions or the entirety of the input device).

FIGS. 7E1-7F illustrate performing a sequence of operations in response to inputs detected by the input device 7024, in accordance with some embodiments. In some embodiments, the input device 7024 is physically split into two portions: the first portion 7024-1 and the second portion 7024-2 of the input device. For example, the first portion 7024-1 and the second portion 7024-2 are magnetically coupled such that, when the ends of the portions of the input device are brought together (e.g., at a distance close enough for the magnets to attract each other), the end portions of the input device snap together (e.g., via the magnets or other mechanical coupling) and operate as a single unit. As described herein, operations performed in response to a respective movement of the input device 7024 as a single unit are optionally distinct operations than the same respective movement performed with one portion of the input device (e.g., first portion 7024-1 and/or second portion 7024-2) while separated from the other portion of the input device. For example, a same drag motion with the input device 7024 as a single unit causes the computer system 7100 to perform a first operation (e.g., to drag an object, as described with reference to FIGS. 7C-7D), and a same, or similar, drag motion with a portion of the input device (e.g., second portion 7024-2) causes the computer system 7100 to perform a second operation (e.g., to change an orientation of an object), distinct from the first operation. In some embodiments, additional operations are enabled while the input device 7024 is split into two portions in accordance with inputs performed with both portions of the input device 7024 (e.g., simultaneously or independently). For example, as described in more detail below, one or more operations are performed in accordance with relative movement between the two portions of the input device 7024.

FIGS. 7E-7H illustrate a sequence of operations that are performed in response to a combination of inputs received from the first portion 7024-1 of the input device and inputs received from the second portion 7024-2 of the input device. In some embodiments, the sequence of operations described below are examples, and that the operations may be combined with additional and/or alternative operations, or the operations may not be performed at all and, optionally, other operations are performed.

FIGS. 7E-7F illustrate a first operation in the sequence of operations that is performed on virtual object 7104. For example, in response to selection of the virtual object 7104 (e.g., in response to detecting a press input on a button of the first portion of the input device 7024 (e.g., same as the button on the input device previously used to select the virtual object 7104 in the process shown in FIGS. 7C-7D, or a different button) while the first portion of the input device 7024 is positioned at a location that corresponds to the virtual object 7104, or in response to detecting a tap input performed using the first portion of the input device 7024 at a location corresponding to the virtual object 7104), the computer system establishes a fixed or substantially fixed spatial relationship between the representation 7024-1′ of the first portion of the input device and the virtual object 7104 in the three-dimensional environment, such that the first portion of the input device may be used as a “handle” of the virtual object to spatially move and rotate the virtual object. For example, as shown in FIG. 5E-5F, the computer system detects that an orientation of the first portion 7024-1 has changed from a first orientation (e.g., parallel to the ground or at a first angle defined relative to the ground) to a second orientation (e.g., perpendicular to the ground or to a second angle defined relative to the ground), as illustrated in FIG. 7F. In some embodiments, in response to detecting an amount of change in orientation of the first portion 7024-1 of the input device (e.g., a change of 90 degrees in a counter-clockwise motion), the computer system changes the orientation of the selected virtual object 7104 by a corresponding amount (e.g., a change of 90 degrees in a counter-clockwise direction). In some embodiments, the computer system further detects translation of the first portion of the input device, and the computer system translates the virtual object according to the translation of the first portion of the input device, e.g., as shown in FIGS. 7E3-7F as well. In some embodiments, while the virtual object 7104 remains selected by the first portion 7024-1 of the input device, the representation 7024-1′ of the first portion 7024-1 of the input device is displayed as attached to, or at least partially overlaying, the virtual object 7104; and the computer system lifts up the virtual object 7104 and controls an orientation and/or position of the virtual object 7104 in accordance with the changes in the orientation and/or position of the first portion 7024-1 of the input device as detected by the computer system. In some embodiments, the computer system is capable of detecting different types of motions executed by the first portion of the input device, including and not limited to a rotation (e.g., in three dimensions, or in a plane) around an internal pivot point in the body of the first portion of the input device (e.g., in the middle, at a first end, or at a second end of the first portion of the input device), a rotation around an external pivot point (e.g., in three dimensions, or in a plane) outside of the body of the first portion of the input device, a rotation around an internal axis along the longitudinal direction of the first portion of the input device, and/or translation in three dimensions or in a plane. In some embodiments, the computer system is capable of detecting different types of attitudes or postures of the first portion of the input device, including but not limited to an upright orientation, a supine orientation, a tiled orientation at a respective angle relative to the direction of gravity or an orientation of a detected surface (e.g., the floor, and/or a tabletop). In some embodiments, the computer system determines the position and/or orientation of the virtual object 7104 based on the detected positions, types of motion, and/or types of attitudes or postures, and/or changes of the above detected properties of the first portion of the input device.

In some embodiments, while the first portion 7024-1 of the input device is held and/or moved to control the orientation and/or position of the virtual object 7104, the computer system optionally detects position, attitude, and/or movements of the second portion 7024-2 of the input device and displays the representation 7024-2′ of the second portion of the input device in the three-dimensional environment 7000′ with a position, attitude, and/or movements that correspond to the position, attitude, and/or movements of the second portion 7024-2 of the input device. In some embodiments, the computer system optionally displays the representation 7024-1′ of the first portion of the input device with a different set of visual properties (e.g., higher color saturation, luminance, and/or opacity) from that (e.g., lower color saturation, luminance, and/or opacity) of the representation 7024-2′of the second portion of the input device, to indicate that the first portion 7024-1 of the input device is currently being used to control the virtual object 7104 and the second portion 7024-2 of the input device is not being used to control the virtual object 7104. In some embodiments, the computer system provides user-adjustable settings to allow a user to establish and/or change which portion of the input device is to be used to control the position, attitude, and/or movements of the virtual object in the manners described with respect to FIGS. 7E1-7F.

In some embodiments, in response to detecting a deselection input from the user (e.g., detecting a tap on a touch-sensitive surface of the first portion of the input device, detecting a press input on a button on the first portion of the input device, detecting physical contact between the first portion and the second portion of the input device (e.g., a tap made by the second portion of the input device on the first portion of the input device, or coupling the two portions together at the first point of physical contact), detecting selection of the virtual object by the second portion of the input device, detecting selection of another virtual object by the user's gaze, and/or another preset input of other input types), the computer system unselects the virtual object 7104 and ceases to move the virtual object 7104 in accordance with the movement of the first portion 7024-1 of the input device after the deselection of the virtual object 7104.

FIG. 7G illustrates the user performing a second operation in the sequence of operations that are performed on virtual object 7104, in accordance with some embodiments. In this example, the computer system modifies a visual property of the virtual object 7104 in accordance with a user input provided via the second portion 7024-2 of the input device. In some embodiments, the second portion 7024-2 of the input device is optionally used to select a respective property from a plurality of visual properties of the virtual object as the target property for modification (e.g., selecting from a menu of visual properties, selecting using checkboxes or radial buttons), and/or used to select a respective value for the currently selected target property (e.g., selecting a value from a plurality of values shown in a menu, slider or palette, and/or selecting from a portion of the three-dimensional environment by sampling the visual property from that portion of the three-dimensional environment). In some embodiments, the computer system detects a sequence of selection inputs provided via the second portion 7024-2 of the input device (e.g., detecting a tap on a touch-sensitive surface of the second portion of the input device or a press input on a button on the first portion of the input device, when the location of the second portion of the input device corresponds to the position of the target visual property or target value for the selected target visual property and/or when a gaze is directed to the target visual property and/or target value for the selected target property), and the computer system selects the target visual property to be modified and selects the target value for the selected target visual property.

In some embodiments, in response to detecting the second portion 7024-2 of the input device tapping at a location that corresponds to a portion of the virtual object 7104 (e.g., a surface or facet of the virtual object 7104), the computer system changes the current value of the target visual property on the portion of the virtual object to the target value of the target visual property. For example, as shown in FIG. 7G, the computer system detects a tap input via the second portion 7024-2 of the input device at a location that corresponds to a first surface of the virtual object 7104, and in response, the computer system changes a color of the first surface from a first color to a second color (e.g., as indicated by the shaded line pattern in FIG. 7G). In some embodiments, the computer system may detect one or more additional inputs via the second portion of the input device to modifies other visual properties of the virtual object 7104 using the second portion 7024-2 of the input device, such as changing a size of the virtual object, a translucency of the virtual object, a texture of the virtual object, and/or a luminance of the virtual object, in the manner described with respect to FIG. 7G. In some embodiments, while the second portion of the input device is used to modify one or more visual properties of

In some embodiments, the computer system performs a resizing operation using both portions of the input device 7024. For example, in FIG. 7G, if the computer system detects that the first portion 7024-1 and the second portion 7024-2 are moving closer together (e.g., both portions moving toward each other, or one portion moving while the other portion is kept stationary, such that the distance between the two portions becomes smaller), the computer system reduces the size of virtual object 7104 in accordance with the updated distance between the first portion 7024-1 and the second portion 7024-2. In some embodiments, virtual object 7104 is resized proportionally or equally to the change in distance between the two portions of input device 7024. In some embodiments, virtual object 7104 is resized in accordance with a speed, or rate of change, of the distance between the two portions of input device 7024. In some embodiments, if the computer system detects that the first portion 7024-1 and the second portion 7024-2 are moving farther apart such that the distance between the two portions increases, the computer system increases the size of the virtual object 7104 (e.g., proportionally or equally) in accordance with the changes in the distance between the two portions of the input device.

FIG. 7H illustrates an example of performing a third operation in the sequence of operations. In some embodiments, while the virtual object 7104 remains selected by the first portion 7024-1 of the input device, the computer system detects rotation of the first portion 7024-1 of the input device (e.g., the user is turning the first portion 7024-1 of the input device about a vertical axis along the center of the first portion 7024-1 of the input device) in a first direction, and in response to detecting the rotation of the first portion of the input device, the computer system rotates the virtual object 7104 about a corresponding vertical axis (e.g., spin or change orientation relative to the vertical axis that passes through the center of the virtual object 7104), such that a second surface of the virtual object is now facing toward the viewpoint of the user (e.g., the second surface is currently shown without any shading, and the first surface with the shading has been moved to face leftward in FIG. 7H).

In some embodiments, inputs using the second portion 7024-2 of the input device and inputs using the first portion 7024-1 of the input device can be detected in sequence or contemporaneously with each other. For example, as illustrated in FIG. 7G, after the rotation of the virtual object 7104 using the first portion of the input device or while rotating the virtual object 7104 in accordance with the movement of the first portion of the input device, the computer system detects an input that changes a visual property (e.g., change a color, change a size, change a translucency, change a luminance, or change a texture) of a second surface of the virtual object 7104 using the second portion 7024-2 of the input device (e.g., in response to a input selecting the second side of the virtual object by the second portion 7024-2 of the input device). For example, as shown in FIGS. 7H-7I, the color of the second surface of the virtual object is changed from the first color to the second color, just like the first surface shown in FIG. 7G. Further, the computer system optionally rotates of the virtual object 7104 in the opposite direction in response to detecting rotation of the first portion 7024-1 in the opposite direction (e.g., counter-clockwise about the vertical axis of the first portion 7024-1 of the input device). In some embodiments, the computer system optionally undoes the change to the visual property of the virtual object (e.g., return the color back to a previous color or return a size back to a previous size) in response to detecting an undo input provided using the second portion 7024-2 of the input device (e.g., tapping a location corresponding to the second surface of the virtual object 7104 again using the second portion 7024-2 of the input device, waving the second portion of the second portion 7024-2 of the input device in the air to form an undo gesture, pressing an undo button on the second portion of the input device, or a preset input of another input type performed by the second portion of the input device). Although in the examples shown in FIGS. 7G-7I, the virtual object 7104 remains selected and controlled by the first portion 7024-1 of the input device, in some embodiments, the operations to modify one or more display properties of the virtual object 7104 are optionally performed in response to inputs provided by the second portion 7024-2 of the input device (e.g., in the manner described herein) while the virtual object 7104 is not selected and controlled by the first portion 7024-1 of the input device.

FIG. 7I illustrates an example of performing a fourth operation (e.g., distinct from the operations described with reference to FIGS. 7C-7H) in accordance with an input provided by the first portion 7024-1 (e.g., and not the second portion 7024-2) of the input device, in accordance with some embodiments. In some embodiments, the computer system requires that the second portion of the input device be removed from the field of view of the three-dimensional environment, in order to perform the fourth operation described herein. In some embodiments, the computer system does not require that the second portion of the input device be removed from the field of view of the three-dimensional environment, in order to perform the fourth operation described herein. For example, the computer system optionally performs the fourth operation while the first portion of the input device is not currently used to select and control the position, attitude, and/or movement of virtual object 7104 or another virtual object in the three-dimensional environment. In some embodiments, whether the first and second portions of the input device are both in the current field of view does not affect the operations performed by the respective portions of the input device.

In this example, the second portion 7024-2 of the input device is placed outside of a current field of view of the three-dimensional environment (e.g., the user puts the right hand with the second portion 7024-2 to the user's side, instead of in front of the user in the physical environment that corresponds to a current view of the three-dimensional environment 7000′). In some embodiments, while first portion of the input device is within the current field of view (e.g., optionally, without the second portion of the input device in the current field of view, or while the first portion of the input device is not currently selecting or controlling another virtual object in the field of view), the computer system performs a fourth operation in response to detecting inputs via the first portion 7024-1 of the input device. In some embodiments, the computer system selects the types of operation performed respectively by the first and second portions of the input device and/or the combination of the first and second portion of the input device, based on user's selection inputs in a settings interface or in a currently displayed user interface. In some embodiments, the user selects respective current modes of operation for the first and second portions of the input device. In some embodiments, the user does not select a current mode of operation, and the computer system automatically detects, based on default settings, user-driven settings, and/or past use of the user, the current mode of operation for a respective portion of the input device. In some embodiments, the fourth operation is selected from an operation to place a first virtual object in the three-dimensional environment (e.g., adding a virtual object, extruding a virtual object from an existing virtual object, and/or duplicating or multiplying a virtual object), applying a visual effect (e.g., turn on virtual lighting, changing virtual lighting, changing wallpaper, changing virtual scene, and/or changing texture) in the three-dimensional environment, changing a first visual property (e.g., font, font size, color, format, texture, and/or style) of virtual text or graphical content, deleting a virtual object or content, removing a visual effect, and/or skipping forward in content. In some embodiments, the computer system selects the location of the fourth operation based on the location of the first portion of the input device at the time when the required input for triggering the fourth operation (e.g., a tap input on a physical surface, or in the air) is provided by the first portion of the input device. In some embodiments, the fourth operation is optionally performed multiple times at multiple locations in response to a sequence of the required inputs (e.g., a sequence of taps on one or more physical surfaces, or in the air) performed by the first portion of the input device. In some embodiments, the computer system detects an input performed by the second portion of the input device that causes performance of a fifth operation that undoes the last performed fourth operation. In some embodiments, the fifth operation is optionally performed multiple times in sequence to undo a sequence of fourth operations that were performed before the fifth operation.

In some embodiments, as illustrated in FIG. 7I, in response to detecting a required input by the first portion 7024-1 of the input device (e.g., a tap input on the surface of physical object 7026, or a tap in the air), the computer system generates and adds a virtual object 7105 in the three-dimensional environment 7000′. In some embodiments, the virtual object 7105 is displayed at a position in the three-dimensional environment 7000′ that corresponds to a location of the input received from the first portion 7024-1 of the input device. For example, in response to detecting a tap input by the first portion of the input device 7024-1 at a first location in the physical environment (e.g., a first location on the surface of physical object 7026), the computer system generates a virtual object at a first position in the three-dimensional environment (e.g., a first position on the surface of the representation 7026′ of the physical object 7026) that corresponds to the first location in the physical environment.

In some embodiments, as illustrated in FIG. 7J, in response to detecting a second input provided by the second portion 7024-2 of the input device (e.g., while the first portion of the input device is not in the current field of view, or when the second portion of the input device is not currently selecting or controlling another virtual object in the three-dimensional environment), the computer system undoes the last operation performed using the first portion of the input device, and removes the virtual object 7105 (e.g., as indicated by the dashed lines) from the three-dimensional environment. In some embodiments, the second input is a tap on a physical surface or a tap in the air by the second portion 7024-2 of the input device. In some embodiments, the undo operation is performed on a previously performed fourth operation at a location that is selected by the location of the second portion of the input device, rather than the last performed fourth operation. For example, if multiple virtual objects have been added by the first portion of the input device, the computer system removes a respective one of the multiple virtual objects in response to detecting a tap on the respective virtual object using the second portion of the input device. In some embodiments, the second input that is required to undo a previously performed fourth operation is a gesture, such as back and forth motion of the second portion of the input device, or a flick gesture by the second portion of the input device. Although the example in FIGS. 7I-7J refers to the operation of adding a virtual object as the fourth operation, other examples of the fourth operation are optionally performed and/or undone in manners analogous to that described with respect to FIGS. 7I-7J, in accordance with various embodiments.

FIGS. 7K-7L illustrate examples of a set of copy operations performed in response to inputs provided via the first portion 7024-1 of the input device and the second portion 7024-2 of the input device, in accordance with some embodiments.

In some embodiments, the first portion 7024-1 of the input device is placed at a location within the physical environment 7000 that is within a currently displayed portion of three-dimensional environment 7000′. For example, the first portion 7024-1 is positioned on a surface of a physical object 7026 for which a representation of the physical object 7026′ is within the three-dimensional environment. In some embodiments, a representation of first portion 7024-1′ of the input device is displayed via the display generation component of computer system 7100. In some embodiments, the first portion 7024-1 of the input device is positioned at a location that corresponds to a position of a virtual object that is displayed within the three-dimensional environment 7000′. For example, in FIG. 7K, the representation of the first portion 7024-1′ of the input device is positioned on top of a displayed virtual texture 7108 based on the location of the first portion 7024-1 of the input device in the physical environment. In some embodiments, the first portion 7024-1 of the input device is placed with an orientation that meets first criteria (e.g., the first portion 7024-1 of the input device is placed upright vertically on the physical surface, or placed with another preset orientation or attitude that corresponds to a request to perform a copy operation or a move operation).

In some embodiments, as shown in FIG. 7K, in response to detecting that the first portion 7024-1 of the input device is placed on a physical surface with an orientation that meets the first criteria (e.g., the first portion 7024-1 of the input device is placed upright vertically on the physical surface, or placed with another preset orientation or attitude that corresponds to a request to perform a copy operation) and at a location that corresponds to a position of the texture 7108 in the three-dimensional environment, a corresponding representation of first portion 7024-1′ is displayed on top of the virtual texture 7108. In addition, the computer system rotates or flips one or more virtual objects about a pivot point indicated by the first portion 7024-1 of the input device. For example, in FIG. 7K, the position of the first portion 7024-1 of the input device defines a pivot point about which a virtual object 7107 rotates around. For example, in response to movement of second portion 7024-2 of the input device (e.g., a clockwise or counter-clockwise motion and/or other translational movement), the computer system moves the virtual object 7107 around the pivot point indicated by the placement location of the first portion 7024-1 of the input device, and displays the virtual object 7107 at a different position (e.g., at the dashed lines indicating area 7109, or another area surrounding the pivot point indicated by the placement location of the first portion of the input device). In some embodiments, the computer system optionally detects the selection of other virtual objects by the second portion of the input device followed by the movement of the second portion of the input device, where the computer system rotates the selected virtual objects around the pivot point indicated by the placement location of the first portion of the input device, in accordance with movement of second portion 7024-2 of the input device about the first portion 7024-1 of the input device. In some embodiments, the one or more selected objects do not overlap with the pivot point. In some embodiments, the pivot point is not on an existing virtual object and is on an unoccupied portion of the three-dimensional environment. In some embodiments, instead of moving the selected virtual object to other positions in the three-dimensional environment around the pivot point set by placement location of the first portion of the input device, the computer system optionally duplicates the selected objects along a movement path around the pivot point (e.g., a circular path, an elliptical path, a rectangular path, or a path of another preset shape that is constrained by the location of the pivot point and the initial distance between the original location of the selected object(s) and the pivot point) in accordance with the movement path of the second portion of the input device (e.g., path of a clockwise or counter-clockwise motion and/or other translational movement).

In some embodiments, the pivot point is identified at a position that overlaps the object that is to be rotated about the pivot point. In some embodiments, placing a pivot point at a corner of an object allows the user to change a direction or otherwise rotate an orientation of the object about the corner. For example, while an object is facing a first direction (e.g., such that the user views a front portion of the object) and a pivot point is indicated on a front corner of the object (e.g., the pivot point being indicated by the first portion 7024-1), movement of the second portion 7024-2 of the input device causes the object to change orientation where the object is facing a second direction, distinct from the first direction. For example, the user is enabled to see the back of the object after changing its orientation by moving the object about the pivot point. In addition, in some cases, the position of the center of the object is also moved in conjunction with the change of the orientation of the object. In some embodiments, placing a pivot point at a center of an object allows the user to change a direction or otherwise rotate an orientation of the object about the corner, without changing the position of the center of the object.

In some embodiments, in response to detecting that the first portion 7024-1 of the input device has been placed on top of the virtual texture 7108, the computer system 7100 copies the virtual texture (e.g., saving it in a clipboard for subsequent pasting and/or move operations). In some embodiments, in response to detecting a user input provided via the second portion 7024-2 of the input device, the computer system pastes the copied virtual texture on an area of the three-dimensional environment 7000′ indicated by the second portion 7024-2 of the input device (e.g., indicated by the location and/or movement path of the second portion of the input device). For example, as illustrated in FIGS. 7K-7L, the area 7109 corresponding to a current position in the three-dimensional environment 7000′ that is indicated by second portion 7014-2 of the input device, is filled with a copy of virtual texture 7108, as illustrated by area 7110 in FIG. 7L. In some embodiments, a translational movement of the second portion of the input device causes the computer system to move a selected object around a pivot point indicated by the first portion of the input device, and a tap input on a physical surface or in the air by the second portion of the input device causes the computer system to apply a texture or paste an object present at a position indicated by the first portion of the input device to a position corresponding to the location of the tap input by the second portion of the input device. In some embodiments, a translational movement of the second portion of the input device causes the computer system to duplicate a selected object or texture along a path indicated by the movement of the second portion of the input device, where the object or texture is selected based on the location of the first portion of the input device.

FIGS. 7L-7M further illustrate that, in response to detecting that the first portion 7024-1 of the input device has moved in the physical environment such that the representation 7024-1′ of the first portion 7024-1 of the input device is positioned over a second virtual texture 7111 in the three-dimensional environment, the computer system copies the second virtual texture 7111. Accordingly, a currently copied texture corresponds to a texture indicated by placement of the first portion 7024-1 of the input device. In FIG. 7L, the computer system detects a user input via the second portion 7024-2 of the input device that indicates another location within the three-dimensional environment 7000′ (e.g., the user taps a location on a physical surface or in the air that corresponds to the target position of the copied texture in the three-dimensional environment), and in response to the user input provided via the second portion of the input device, the computer system displays a copy of the second virtual texture 7111 at the location (e.g., area 7112, FIG. 7M) within the three-dimensional environment 7000′ indicated by the second portion 7024-2 of the input device. In some embodiments, the shape of the area from which a texture is selected by the first portion of the input device is not used by the computer system to constrain the shape of the area to which the texture is pasted. For example, a texture is optionally selected using the first portion of the input device from a virtual sphere and applied to a virtual wall or a virtual block selected by the second portion of the input device.

FIG. 7N illustrates placing the second portion 7024-2 in the physical environment in a mode of operation such that a representation of the three-dimensional environment 7000′ is displayed by the computer system 7100 from a point-of-view determined by the position of the second portion 7024-2 of the input device. For example, the second portion 7024-2 is placed on a surface of an object in the physical environment (e.g., on a table or on the floor), such that the three-dimensional environment 7000′ is displayed from the perspective (e.g., as a camera view) of the second portion 7024-2 of the input device. In response to detecting movement of the second portion of the input device in the physical environment from a first location to a second location, and/or rotation of the second portion of the input device from a first orientation to a second orientation, the computer system changes the view of the three-dimensional environment based on a movement and/or rotation of the viewpoint that is determined according to the movement and rotation of the second portion of the input device. In an example, the second portion of the input device serves as a proxy of the user or the head-mounted display to move the viewpoint into the three-dimensional environment to a position and/or at a scale that is not practical or possible for the user or the head-mounted display generation component.

As shown in the examples in FIGS. 7A-7N, the display generation component of computer system 7100 is a touch screen held by user 7002. In some embodiments, the display generation component of computer system 7100 is a head-mounted display worn on user 7002's head (e.g., what is shown in FIGS. 7A-7N as being visible via the display generation component of computer system 7100 corresponds to the user 7002's field of view when wearing a head-mounted display). In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component is optionally moved and rotated by the user's hand relative to the physical environment or relative to the user's head and changes the viewpoint of the user in the three-dimensional environment in accordance with the movement of the display generation component relative to the user's head or face or relative to the physical environment.

Additional descriptions regarding FIGS. 7A-7N are provided below in reference to method 800 described with respect to FIGS. 7A-7N.

FIG. 8 is a flow diagram of an exemplary method 800 for interacting with a three-dimensional environment using predefined input gestures, in accordance with some embodiments. In some embodiments, method 800 is performed at a computer system (e.g., computer system 101 in FIG. 1A, computer system 7100 and/or computer system 7100a) including a display generation component (e.g., display generation component 120 in FIGS. 1A, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the computer system is in communication with an input device (e.g., input device 7024). In some embodiments, the method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

The method 800 relates to interactions using an input device that is optionally separated into two distinct parts, such that a user is enabled to navigate and control objects in a three-dimensional environment, with different operations being performed with the input device depending on whether the input device is being used a single unit, separated into portions, and/or which of the separate portions of the input device are being used to provide inputs. Automatically detecting whether an input device has been physically decoupled into two distinct portions, without requiring the user to manually change input device settings, reduces the number of inputs needed to switch between using the input device as a single unit and as two distinct portions. Further, performing different operations based on which portion of the input device is maneuvered, and/or how the portions are maneuvered in combination (e.g., relative to each other), provides additional control options for the user without displaying additional controls. Reducing the number of user input and providing additional control options to the user enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the computer system is in communication with one or more cameras, a display generation component, and an input device. The input device includes (802) a first portion of the input device and a second portion of the input device that are physically coupled in a first configuration and physically decoupled in a second configuration. For example, input device 7024 is illustrated in the first configuration in FIGS. 7B-7D and the input device 7024 is illustrated in the second configuration in FIGS. 7E (e.g., FIGS. 7E1-7E3)-7N, wherein in the second configuration, the input device 7024 is physically decoupled in the second configuration as first portion 7024-1 and second portion 7024-2 of the input device 7024. In some embodiments, the first portion of the input device and the second portion of the input device are two segments of a wand-like device that are physically joined to each other (e.g., first configuration) via a physical connection in the first configuration, where the physical connection is formed via a magnetic connector, a mechanical connector, or any of other types of coupling structures or mechanisms. In some embodiments, the two segments of the wand-like device are physically separated from each other (e.g., second configuration) when pulled apart by force, or in response to the user activating a release or ejection mechanism of the physical connection. In some embodiments, the first portion of the input device and the second portion of the input device form a nested structure, with one portion of the input device at least partially enclosed in the other portion of the input device (e.g., in the first configuration). In some embodiments, the inner portion (e.g., second portion 7024-2) of the input device can be taken out of the outer portion (e.g., first portion 7024-1) of the input device (e.g., in the second configuration) when the inner portion is pulled away from the outer portion, or when a release or ejection mechanism of the physical connection is activated by the user. In some embodiments, the first portion and the second portion of the input device have a fixed or constrained spatial relationship with each other and are in physical contact with each other in the first configuration. In some embodiments, the first portion and the second portion of the input device do not have a fixed or constrained spatial relationship with each other and are not in physical contact with each other in the second configuration.

The computer system displays (804), via the display generation component, a three-dimensional environment that corresponds to a physical environment surrounding the input device, wherein displaying the three-dimensional environment includes displaying one or more virtual objects (e.g., application windows, user interface objects, pass-through objects, or controls) in the three-dimensional environment (e.g., in a VR, AR, or XR environment). For example, virtual object 7104 is displayed in three-dimensional environment 7000′, as illustrated in FIGS. 7B-7N.

While displaying the three-dimensional environment, the computer system detects (806), via the input device while the first portion of the input device is coupled (e.g., is not physically separated, is magnetically connected, or is mechanically connected) to the second portion of the input device in the first configuration, a first input. In some embodiments, the input that is detected comprises translational movement of the input device as a whole in the physical environment that corresponds to a request to perform a drag operation on the first user interface object, comprises flick movement of the input device as a whole in the physical environment that corresponds to a request to invoke a menu associated with the first user interface object, or comprises activation of a button on the input device to invoke a preset system function or a preset application function. For example, as illustrated in FIGS. 7C-7D, while in the first configuration, an input is detected by the user selecting, using input device 7024, virtual object 7104 and moving input device 7024 from left to right, relative to a perspective of the user, in the physical environment 7000, that corresponds to a request to perform a drag operation of virtual object 7104.

In response to detecting the first input while the first portion of the input device is coupled to the second portion of the input device in the first configuration, the computer system performs (808) a first operation in the three-dimensional environment. For example, the first operation comprises translating a first user interface object, rotating a first user interface object, displaying a menu associated with a first user interface object, displaying a system menu, generating a system sound, or launching a preset application in the three-dimensional environment. In some embodiments, the first operation is associated with a first user interface object that is located in the three-dimensional environment at a first location that is pointed at or directed to by the input device. In some embodiments, performing the first operation optionally includes changing an appearance, location, posture, attitude, or arrangement of the first user interface object, and optionally, changing other aspects of the three-dimensional environment.

While the first portion of the input device and the second portion of the input device are decoupled in the second configuration (e.g., after the first operation is performed and after a user action causes the first portion of the input device to be separated from the second portion of the input device), the computer system detects (810) a sequence of one or more inputs that includes movement of the first portion of the input device relative to the second portion of the input device. For example, the sequence of one or more inputs includes movements of the first portion and/or the second portion of the input device that occur after the first portion and the second portion of the input device have been physically separated from each other, as described with reference to FIGS. 7E (e.g., FIGS. 7E1-7E3)-7N while first portion 7024-1 is separated from second portion 7024-2 of the input device.

In response to detecting the sequence of one or more inputs, the computer system performs (812) one or more operations based on the sequence of one or more inputs that includes the movement of the first portion of the input device relative to the second portion of the input device, wherein the one or more operations are different from the first operation. For example, the one or more operations include rotating the first user interface object around a pivot point, copying and pasting textures from one location to another location, modifying the first user interface object and undoing the modification, and/or one or more additional operations. For example, FIGS. 7E (e.g., FIGS. 7E1-7E3)-7F illustrate an operation to change an orientation of virtual object 7104, FIGS. 7G-7H illustrate changing a visual property of the virtual object 7104 and rotating the virtual object 7104, FIGS. 7I-7J illustrate creating and removing a virtual object 7105, and FIGS. 7K-7M illustrate copying and pasting various textures. In some embodiments, the sequence of inputs is performed by the input device as a whole (e.g., a combination of how the first portion 7024-1 interacts with the second portion 7024-2). In some embodiments, performing the one or more operations based on the sequence of one or more inputs that includes the movement of the first portion of the input device relative to the second portion of the input device includes changing a direction, magnitude, speed, rate of change, or a type of operation based on one or more characteristics (e.g., a direction, magnitude, speed, rate of change, or a type) of the movement of the first portion of the input device relative to the second portion of the input device.

In some embodiments, after performing the first operation (e.g., while the effect of the first operation persists in the three-dimensional environment, or after the effect of the first operation has ceased in the three-dimensional environment due to lapse of time or additional user interactions), the computer system detects (e.g., via sensors embedded in the physical connection of the first and second portions of the input device, via sensors embedded in the first and/or second portions of the input device, and/or via external sensors outside of the input device) that the input device has separated (e.g., in response to a user physically splitting (e.g., dividing or otherwise decoupling) the input device) into the first portion of the input device and the second portion of the input device. For example, in FIGS. 7D-7E (e.g., FIGS. 7E1-7E3), the computer system detects that the input device 7024 has been split into first portion 7024-1 and second portion 7024-2 of the input device. In some embodiments, in response to detecting that the input device has separated into the first portion and the second portion of the input device (e.g., that the input device is in the second configuration), the input device exits a first input mode in which movement of the input device as a whole is used to determine what operations are performed and how those operations are performed, and the input device enters into a different operation mode in which the relative movement of the first portion and the second portion of the input device are used to determine what operations are performed and how those operations are performed. In some embodiments, while the input device is in the second operation mode, the movement of the first portion of the input device while the second portion of the input device is kept substantially stationary causes performance of one operation, while the movement of the second portion of the input device while the first portion of the input device is kept substantially stationary causes performance of a different operation; and the operations performed in response to the movements of the different portions of the input device are different from each other, and are different from the operations performed in response to the movements of the input device as a whole. Automatically detecting that an input device has been physically decoupled into two distinct portions, without requiring the user to manually change input device settings, reduces the number of inputs needed to switch between using the input device as a single unit and as two distinct portions.

In some embodiments, performing the first operation includes performing a drag operation on a first object of the one or more virtual objects in the three-dimensional environment. For example, the first operations include performing a drag operation to move a user interface object (e.g., virtual object 7104, FIGS. 7C-7D), or includes performing a copy and paste operation on a virtual representation of an object in the physical environment (e.g., a copy and paste operation of a texture 7108 displayed on a surface, wherein the paste locations are indicated by the drag operation, as illustrated in FIG. 7K). In some embodiments, the first object is a currently selected object in the three-dimensional environment. In some embodiments, the first object is selected based on the location of the input device at the time of the movement of the input device as a whole. In some embodiments, performing the one or more operations based on the one or more inputs that includes the movement of the first portion of the input device relative to the second portion of the input device includes performing a second operation that changes an orientation of the first object relative to a current viewpoint of the user, and performing a third operation that modifies the first object. For example, in some embodiments, the sequence of one or more inputs comprises a second input (e.g., to lift the first object 7104 and/or turn the object 7104, as described in FIGS. 7E (e.g., FIGS. 7E1-7E3)-7F and 7H) performed with the first portion of the input device (e.g., first portion 7024-1) and a third input (e.g., a tap input) performed with the second portion of the input device, wherein the second input causes the computer system to perform a distinct operation than the third input. For example, as described with reference to FIGS. 7E (e.g., FIGS. 7E1-7E3)-7G, the second input with first portion 7024-1 of the input device causes the virtual object 7104 to change direction and the third input performed with second portion 7024-2 modifies one or more visual properties of the virtual object 7104 (e.g., the object's color, texture, and/or translucency is changed in FIG. 7G in response to the third input). Performing a first operation, such as a drag operation if an input device is functioning as a single unit, and performing a distinct operation, such as changing an orientation and/or modifying an object using the input device as two separated units, provides additional control options for the user without displaying additional controls.

In some embodiments, performing the one or more operations, optionally while the first and second portions of the input device are decoupled in the second configuration, based on the sequence of one or more inputs include performing a fourth operation with respect to a second object of the one or more virtual objects displayed in the three-dimensional environment and performing a fifth operation with respect to the second object, the fifth operation being distinct from the fourth operation. In some embodiments, the second object is the same object as the first object mentioned above (e.g., virtual object 7104). In some embodiments, the second object is a different object from the first object mentioned above. For example, in some embodiments, the sequence of one or more inputs comprise a fourth input (e.g., to lift the first object and/or turn the object 7104) performed with the first portion of the input device and a fifth input (e.g., a tap input, a drag input, or other selection input) performed with the second portion of the input device, wherein the fourth input causes the computer system to perform a distinct operation than the fifth input (e.g., the fourth input causes the object to change direction and the fifth input modifies one or more visual properties of the object (e.g., the object's color, texture and/or translucency), but the operations are performed with respect to the same object. For example, in FIGS. 7F-7H, one input is performed (e.g., via second portion 7024-2 of the input device) to change a visual property of virtual object 7104, and another input is performed (e.g., using first portion 7024-1 of the input device) to rotate the virtual object relative to the perspective of the user. Performing different sets of operations, based on a determination of whether both parts of the input device, or only one part of the input device, are being manipulated by the user, provides additional control options for the user without displaying additional controls.

In some embodiments, performing the fourth operation includes changing a position of the second object relative to a current viewpoint of the user. In some embodiments, the position of the second object is changed in accordance with one or more user inputs detected via the first portion of the input device. For example, in FIGS. 7E (e.g., FIGS. 7E1-7E3)-7F, the first portion 7024-1 of the input device selects virtual object 7104, and movement of the first portion 7024-1 in the physical environment 7000 causes the computer system to move the virtual object 7104 accordingly. For example, an upward movement of first portion 7024-1 causes virtual object 7104 to be displayed as lifted off the surface, and translational movement (e.g., to the left or right relative to the user's perspective), causes virtual object 7104 to be displayed as moving laterally in accordance with the translational movement (e.g., virtual object 7104 moves to the left as the first portion 7024-1 is moved to the left in the physical environment 7000). In some embodiments, performing the fifth operation includes modifying one or more visual properties of the second object (e.g., changing a color, size, shape, translucency or texture of the second object). In some embodiments, modifying the one or more visual properties of the second object is performed in accordance with one or more user inputs detected via the second portion of the input device. For example, the second portion of the input device acts as a paintbrush such that, as the user moves the second portion of the input device to select a portion of the second object, the selected portion changes color (e.g., as if being painted with a paintbrush), as illustrated in FIG. 7G. For example, in FIG. 7H, if the user selects an additional portion (e.g., another surface or side) of the second object using the second portion 7024-2 of the input device, the selected additional portion also changes color (e.g., as illustrated in FIG. 7I). Automatically performing different operations with distinct portions of an input device, without requiring the user to manually select which controls to activate for each the respective portion of the input device, reduces the number of inputs needed to control the device by using each of the distinct portions for performing a different task.

In some embodiments, performing the one or more operations, while the first and second portions of the input device are decoupled in the second configuration, based on the sequence of one or more inputs include performing a sixth operation that adds (e.g., creates, pastes, or draws) a third object to a portion of the three-dimensional environment (e.g., at a location selected by a position of one of the first portion or second portion of the input device or at a location in the currently displayed view of the three-dimensional environment). For example, virtual object 7105 is created in FIG. 7I. In some embodiments, performing the one or more operations based on the sequence of one or more inputs further includes performing a seventh operation that removes the third object from the portion of the three-dimensional environment. For example, the seventh operation includes ceasing to display the third object as a result of the seventh operation, as described with reference to FIG. 7J. In some embodiments, the sixth operation is performed using one portion of the input device (e.g., first portion 7024-1) for creating content (e.g., a virtual object or a virtual visual effect) in a portion of the three-dimensional environment, and the seventh operation is performed using the other portion of the input device (e.g., second portion 7024-2) for undoing the content creation (e.g., removing the virtual object or removing the virtual visual effect). Using two distinct portions of an input device to perform and undo a same action, such as adding an object with a first portion of the input device and removing the object with the second portion of the input device, reduces the number of inputs needed to control the input device and provides the user with additional control options without displaying additional controls by allowing the user to control each portion independently such that the user performs a different task with each portion.

In some embodiments, performing the one or more operations, while the first and second portions of the input device are decoupled in the second configuration, based on the sequence of one or more inputs include performing a single operation based on a respective input received from the first portion of the input device and a respective input received from the second portion of the input device. For example, the single operation comprises, a rotation, a measurement, or a change in position that is directed to a fourth object of the one or more virtual objects displayed in the three-dimensional environment. In some embodiments, both portions of the input device are used concurrently to perform the operation. In some embodiments, a location of the first portion of the input device is detected in conjunction with a rotational movement of the second portion of the input device around the first portion of the input device. For example, the first portion 7024-1 is placed on a surface, as illustrated in FIG. 7K, and the position of the first portion 7024-1 is used as a pivot point, while the second portion 7024-2 is moved to cause the object to rotate about the pivot point indicated by the position of first portion 7024-1 of the input device. In some embodiments, a location of the second portion of the input device detected in conjunction with translational movement of the first portion of the input device, relative to the second portion of the input device (e.g., moving the first portion of the input device away from, or closer to, the second portion of the input device and/or tapping the first portion of the input device against the second portion of the input device). Using information acquired from two distinct portions of an input device to perform a same operation enables the user to perform detailed tasks that requires information from two or more inputs using the same input device without displaying additional controls.

In some embodiments, performing the single operation based on a respective input received from the first portion of the input device and a respective input received from the second portion of the input device includes rotating a fourth object of the one or more virtual objects in the three-dimensional environment (or rotating a scene that includes the fourth object and one or more additional virtual objects) relative to a pivot point in the three-dimensional environment in accordance with movement of the first portion of the input device, wherein the pivot point is selected based on a position of the second portion of the input device in the three-dimensional environment. In some embodiments, the pivot point corresponds to a current position of the second portion of the input device (e.g., a position of second portion 7024-2 in physical environment 7000 and/or within the three-dimensional environment 7000′). In some embodiments, the pivot point at least partially overlaps the fourth object (e.g., a corner of the fourth object or a center of the fourth object). In some embodiments, the pivot point is at a location that does not overlap the fourth object. In some embodiments, the first portion of the input device moves around the second portion of the input device or the pivot point to cause the fourth object to change positions (e.g., rotate) around the pivot point. In some embodiments, the respective roles of the first portion of the input device and the second portion of the input device are reversed in performing the above-mentioned rotation operation (e.g., the pivot point is selected based on the position of the first portion of the input device, and the rotation of the fourth object or the scene is based on the movement of the second portion of the input device relative to the first portion of the input device). For example, in FIG. 7L, the position of first portion 7024-1 on the surface in the physical environment 7000 identifies a pivot point (e.g., at a point that corresponds to second texture 7111), and second portion 7024-2 is enabled to rotate virtual object 7104 around the pivot point to change a position of virtual object 7104 (e.g., to view another side of the virtual object 7104 from a different angle of perspective, at another position in the three-dimensional environment 7000′). Using information acquired from two distinct portions of an input device to perform a same operation enables the user to perform detailed tasks that require two or more inputs, for example, an input to identify a pivot point and an input to rotate an object about the pivot point, using the same input device without displaying additional controls.

In some embodiments, detecting the sequence of one or more inputs includes detecting placement of the second portion of the input device (e.g., on a surface, such as a table or a floor) in the three-dimensional environment. In some embodiments, while the second portion is placed on the surface, the second portion of the input device is left stationary (e.g., the user is not holding or moving the second portion of the input device). In accordance with a determination that the placement of the second portion of the input device meets preset criteria (e.g., the second portion of the input device is placed on a flat surface, and the second portion of the input device remains substantially stationary on the flat surface for at least a threshold amount of time, etc.), the computer system uses a location (and, optionally, an orientation, a tilt angle, a facing direction, an angle relative to the direction of gravity, an angle relative to a reference surface, etc.) of the second portion of the input device as a basis for determining a viewpoint (e.g., position, viewing angle, viewing direction, etc.) from which to generate a view of the three-dimensional environment, as illustrated in FIG. 7N (e.g., POV of the second portion 7024-2 (e.g., as placed on the top surface of the physical object 7026) is used to generate the view of the three-dimensional environment shown in FIG. 7N). For example, while the second portion of the input device is placed on a surface or at a position inside of a three-dimensional object (e.g., within a virtual structure, such as a virtual house), the mode of input is a virtual point-of-view (POV) camera from the perspective of the second portion of the input device (e.g., the second portion of the input device is used as a POV marker. In some embodiments, a representation of the generated view of the three-dimensional environment from a perspective relative to the second portion of the input device is displayed for the user (e.g., as if the second portion of the input device had a camera that was capturing the three-dimensional environment). Allowing a user to specify a marker point by placing one portion of an input device at a location, and automatically updating display from the perspective of the marker point as the marker point changes relative to the three-dimensional environment, improves visual feedback of the user such that the user can navigate around the three-dimensional environment by moving the one portion of the input device.

In some embodiments, the one or more operations performed are selected based at least in part on a currently selected mode of operation of the input device (e.g., a user selects to put the input device in a mode for modifying visual properties of an object, a mode for copying and/or pasting an object, or a mode for displaying the three-dimensional environment from a viewpoint corresponding to the placement location and angle of the second portion of the input device). In some embodiments, the computer system automatically determines a current mode of operation of the input device (e.g., by inferring, based on the user's movement of the input device and/or based on the user's interaction history with the input device and the three-dimensional environment) without additional user input (e.g., the user does not explicitly change modes), and operates in the determined mode.

In some embodiments, before detecting the sequence of one or more inputs, the computer system detects that the input device transitions from the first configuration to the second configuration, including, detecting that the first portion of the input device is physically separated from contact with the second portion of the input device (e.g., after the scenario shown in FIG. 7D and before the scenario shown in FIGS. 7E (e.g., FIGS. 7E1-7E3), the computer system detects separation of the input device 7024 (FIG. 7D) into first portion 7024-1 and second portion 7024-2 (FIG. 7E)). For example, detecting the transition includes detecting more than a threshold amount of reduction of a magnetic force exerted by the first portion of the input device on the second portion of the input device, detecting cessation of physical contact between the first portion of the input device and the second portion of the input device, and/or detecting a lock or fastener between the first and second portions of the input device entering from an engaged state or an unengaged state. Automatically detecting that an input device has been physically decoupled into two distinct portions, without requiring the user to manually change input device settings, reduces the number of inputs needed to switch between using the input device as a single unit and as two distinct portions.

In some embodiments, detecting the sequence of the one or more inputs includes detecting a selection input (e.g., an air gesture, a tap input, a double tap input, or a placement of a portion of the input device at a location of a subject of the selection) and detecting a drag input after detecting the selection input (e.g., detecting the drag input without detecting another input that is different from the selection input that has already been detected). In some embodiments, the selection input and drag input are performed with the same portion of the input device. In some embodiments, the selection input is performed with the first portion of the input device and the drag input is performed with the second portion of the input device. In some embodiments, performing the one or more operations based on the sequence of one or more inputs includes, in response to detecting the selection input, performing a copy operation that copies a portion of the three-dimensional environment corresponding to a position of the selection input (e.g., the texture and/or surface on which the selection input is detected, is copied), and, in response to detecting the drag input after detecting the tap input, displaying a copy of the portion of the three-dimensional environment in one or more additional portions of the three-dimensional environment (e.g., copying the texture to another portion of the three-dimensional environment) in accordance with the drag input, as described with reference to FIGS. 7K-7M (e.g., after selecting an object or texture 7108 in response to detecting a user tapping the first portion 7024-1 on the object or texture 7108 in FIG. 7K, the computer system detects the user dragging the first portion 7024-1 and duplicates the object or applies the texture at positions indicated by the movement path of the first portion 7024-1 of the input device; or after selecting an object or texture 7108 in response to detecting a user tapping the first portion 7024-1 on the object or texture 7108 in FIG. 7K, the computer system detects the user dragging the second portion 7024-2 and duplicates the object or applies the texture at positions indicated by the movement path of the second portion 7024-2 of the input device (e.g., as shown in FIGS. 7L-7M)). In some embodiments, the one or more additional portions are determined based on where the drag input is detected within the three-dimensional environment. For example, in some embodiments, as the drag input (or other detected movement of the second portion of the input device) moves onto other portions in the three-dimensional environment, the texture and/or surface that corresponds to the selection input (e.g., the texture or surface that was displayed at the location of the second portion of the input device when the tap input was detected) is copied and displayed at the positions indicated by the drag input (e.g., along the path of the drag input). Allowing a user to copy and paste a portion of a virtual environment by maneuvering a same physical input device to perform both the copy operation and the paste operation, without requiring the user to specify each operation individually by selecting a corresponding control from a menu, reduces the number of inputs needed to perform the copy and paste operations without displaying additional controls.

In some embodiments, detecting the sequence of the one or more inputs includes detecting placement of the second portion of the input device on a surface corresponding to a fifth virtual object of the one or more virtual objects in the three-dimensional environment. In some embodiments, detecting placement of the second portion of the input device comprises detecting the second portion of the input device is set down on a physical surface that corresponds to a virtual object (e.g., the fifth virtual object). In some embodiments, the fifth virtual object is placed relative to (e.g., on top of or next to) the physical surface in the three-dimensional environment and/or is touching the physical surface or is virtually touching the virtual object using the second portion of the input device to select the object that is to be rotated. In some embodiments, while the second portion of the input device is placed on the surface corresponding to the fifth virtual object of the one or more virtual objects in the three-dimensional environment, the computer system detects rotation of the second portion of the input device around an internal pivot point of the second portion of the input device, optionally while the first portion of the input device remains substantially stationary, and performing the one or more operations based on the sequence of one or more inputs includes rotating the fifth object relative to an internal pivot point of the fifth object in accordance with corresponding to the rotation of the second portion of the input device. In some embodiments, the fifth virtual object is rotated relative to the current viewpoint of the user (e.g., the pivot point is the center of the fifth virtual object) such that the user rotates the fifth virtual object (e.g., to view the object at different angles) without changing the position of the fifth virtual object within the three-dimensional environment. In some embodiments, the respective roles of the first portion of the input device and the second portion of the input device are reversed in performing the above-mentioned rotation operation (e.g., the first portion of the input device is placed on the surface corresponding to the fifth virtual object, and the above-mentioned of the fifth virtual object is based on the rotation of the first portion of the input device around its internal pivot point). For example, in FIGS. 7G-7H, after the first portion 7024-1 of the input device is set down at a location that corresponds to a virtual object 7104 in FIG. 7G, the virtual object 7104 is selected; and in response to detecting rotation of the first portion 7024-1 of the input device around an internal pivot point of the first portion 7024-1 of the input device (e.g., the user rotates the first portion 7024-1 around a center of the first portion, or around a longitudinal axis of the first portion, optionally while the first portion is placed at the same location), the computer system rotates the virtual object 7104 around an internal pivot point of the virtual object (e.g., rotating the virtual object its axis by an amount based on the rotation of the first portion 7024-1 of the input device. In another example, in FIG. 7K, after the first portion 7024-1 of the input device is set down at a location that corresponds to a virtual object represented by two squares (e.g., outline of object 7107 and the outline of texture 7108 as shown in FIG. 7K), the virtual object is selected; and in response to detecting rotation of the first portion 7024-1 of the input device around an internal pivot point of the first portion 7024-1 of the input device (e.g., the user rotates the first portion 7024-1 around a center of the first portion, or around a longitudinal axis of the first portion), the computer system rotates the virtual object around an internal pivot point of the virtual object (e.g., rotating the virtual object around the position indicated by the first portion 7024-1 of the input device by an amount based on the rotation of the first portion 7024-1 of the input device. Allowing a user to rotate a virtual object within a virtual environment by maneuvering a same portion of a physical input device, based on the spatial location and the rotation of the input device, enables the user to control the rotation of a virtual object using a single, physical input device without displaying additional controls.

In some embodiments, detecting the sequence of the one or more inputs includes detecting placement of the first portion of the input device on a surface corresponding to a sixth virtual object of the one or more virtual objects in the three-dimensional environment. For example, detecting that the first portion of the input device is set down on a physical surface that corresponds to a virtual object, wherein the virtual object is optionally placed relative to the physical surface in the three-dimensional environment. In some embodiments, detecting placement of the first portion of the input device on the surface comprises physically touching the physical surface or virtually touching the virtual object using the first portion of the input device to select the object. In some embodiments, while the first portion of the input device is placed on the surface corresponding to the sixth virtual object of the one or more virtual objects in the three-dimensional environment, the computer system detects rotation of the second portion of the input device around an internal pivot point of the second portion of the input device, optionally while the first portion of the input device remains substantially stationary on the surface corresponding to the sixth virtual object. In some embodiments performing the one or more operations based on the sequence of one or more inputs includes rotating the sixth object relative to an internal pivot point of the sixth object in accordance with the rotation of the second portion of the input device. In some embodiments, the sixth virtual object is rotated (e.g., turned or changed in orientation) relative to the current viewpoint of the user (e.g., the pivot point is the center of the sixth virtual object) such that the user rotates the sixth virtual object (e.g., to view the object at different angles) without changing the position of the sixth virtual object within the three-dimensional environment. For example, after the first portion 7024-1 of the input device is set down at a location that corresponds to a virtual object represented by two squares (e.g., outline of object 7107 and the outline of texture 7108 as shown in FIG. 7K), the virtual object is selected; and in response to detecting rotation of the second portion 7024-2 of the input device around an internal pivot point of the second portion 7024-2 of the input device (e.g., the user rotates the second portion 7024-2 around a center of the second portion, or around a longitudinal axis of the second portion), the computer system rotates the virtual object around an internal pivot point of the virtual object (e.g., rotating the virtual object around the position indicated by the first portion 7024-1 of the input device by an amount based on the rotation of the second portion 7024-2 of the input device). In some embodiments, the direction and amount of the rotation executed by the sixth virtual object around the center of the sixth virtual object are determined based the direction and amount of the rotation executed by the second portion of the input device around the center of the second portion of the input device. In some embodiments, the respective roles of the first portion of the input device and the second portion of the input device are reversed in performing the above-mentioned rotation operation (e.g., the second portion of the input device is placed on the surface corresponding to the sixth virtual object, and the above-mentioned of the sixth virtual object is based on the rotation of the first portion of the input device around its internal pivot point). Using information acquired from two distinct portions of an input device to perform a same operation enables the user to perform detailed tasks that require two or more inputs, for example, an input to identify an object and an input to rotate the identified object to view the object from different angles, using the same input device without displaying additional controls.

In some embodiments, detecting the sequence of the one or more inputs includes detecting placement of the first portion of the input device at a first location that corresponds to a first texture in the three-dimensional environment. In some embodiments, the first texture includes a texture image or respective values for a preset of visual characteristics such as color, pattern, brightness, opacity, and/or blur radius. In some embodiments, detecting placement of the first portion of the input device at the first location that corresponds to the first texture includes detecting the first portion of the input device coming into contact with an object that has a representation at the first location in the three-dimensional environment, detecting the first portion of the input device moving within a threshold distance of the first location in the three-dimensional environment, and/or detecting that the first portion of the input device remaining substantially stationary for at least a threshold amount of time within a threshold distance of the first location. In some embodiments, while the first portion of the input device is placed at the first location, wherein the first portion of the input device optionally remains substantially stationary at the first location, detecting placement of the second portion of the input device at a second location, wherein the second location optionally corresponds to a second texture or that has no currently used texture, in the three-dimensional environment. In some embodiments, detecting placement of the second portion of the input device at the second location includes detecting the second portion of the input device coming into contact with an object that has a representation at the second location in the three-dimensional environment, detecting the second portion of the input device moving within a threshold distance of the second location in the three-dimensional environment, and/or detecting that the second portion of the input device remaining substantially stationary for at least a threshold amount of time within a threshold distance of the second location. In some embodiments, performing the one or more operations based on the sequence of one or more inputs includes copying the first texture corresponding to the first location in the three-dimensional environment and displaying the copied first texture at the second location in the three-dimensional environment. In some embodiments, as the second portion of the input device moves in the three-dimensional environment after the initial placement at the second location, the first texture is further copied to and displayed at one or more additional positions in the three-dimensional environment indicated by a position of the second portion of the input device, as described with reference to FIGS. 7K-7M (e.g., while the first portion 7024-1 of the input device is placed over the first texture 7108 and selects the first texture 7108, movement of the second portion 7024-2 of the input device or tapping the second portion 7024-2 of the input device at other locations cause the first texture 7108 to be applied along the movement path or the tapped position(s) indicated by the second portion 7024-2 of the input device). In some embodiments, a confirmation input is provided via the second portion of the input device in order for the first texture to be copied to a new location. In some embodiments, further confirmation inputs are not required as the second portion of the input device is moved continuously along a path after an initial confirmation input is already provided, in order for the texture to be copied to additional locations along the path. In some embodiments, the respective roles of the first portion of the input device and the second portion of the input device are reversed in performing the above-mentioned copy and paste operation (e.g., the second portion of the input device is placed on the first location to copy the first texture, and the first texture is displayed at locations indicated by the placement of the first portion of the input device). Using information acquired from two distinct portions of an input device to perform related operations enables the user to perform detailed tasks that require two or more inputs, for example, an input to identify a texture to be copied and an input to identify the additional locations to place the copied texture, using the same input device without displaying additional controls.

In some embodiments, the computer system detects movement of the first portion of the input device from the first location and placement of the first portion of the input device at a third location that corresponds to a second texture in the three-dimensional environment. In some embodiments, the first location and placement of the first portion of the input device corresponds to a third position in the three-dimensional environment that has a second texture, which is optionally distinct from the first texture. In some embodiments, in response to detecting placement of the first portion of the input device at the third location that corresponds to the second texture in the three-dimensional environment, the computer system copies the second texture corresponding to the third location in the three-dimensional environment and displays the copied second texture at one or more locations indicated by the second portion of the input device in the three-dimensional environment. In some embodiments, the computer system optionally updates display of the copied first texture at the second location to display the second texture as well. In some embodiments, as the first portion of the input device is moved to different textures (e.g., to different positions in the three-dimensional environment that correspond to different textures), the new areas indicated by the second portion of the input device (e.g., by a drag input detected using the second portion of the input device over the additional locations) are updated to copy the texture that is currently indicated by the first portion of the input device. For example, as described in FIGS. 7K-7M, while the first portion 7024-1 of the input device is placed over the first texture 7108 and selects the first texture 7108, movement of the second portion 7024-2 of the input device or tapping the second portion 7024-2 of the input device at other locations cause the first texture 7108 to be applied along the movement path or the tapped position(s) indicated by the second portion 7024-2 of the input device. When the first portion 7024-1 of the input device is then moved from the first texture to a second texture 7111, the second texture becomes selected, and subsequently moving or tapping the second portion 7024-2 of the input device causes the second texture to be applied along the movement path or the tapped position(s) indicated by the second portion 7024-2 of the input device. In some embodiments, the respective roles of the first portion of the input device and the second portion of the input device are reversed in performing the above-mentioned copy and paste operation (e.g., the second portion of the input device is moved from the first location and placed at the third location to copy the second texture, and the second texture is displayed at locations indicated by the placement of the first portion of the input device). In some embodiments, after copying texture 7108 to the area 7110 (e.g., as described with reference to FIG. 7L), the computer system detects the first portion 7024-1 of the input device has moved from a position overlapping the texture 7108 (FIG. 7K) to a position overlapping the second texture 7111, and in response to the change in position of the first portion 7024-1 of the input device, the computer system updates the copied area 7110 to display the second texture 7111 indicated by the current position of the first portion 7024-1 of the input device, instead of maintaining the area 7110 as having the same copied texture as texture 7108. Using information acquired from two distinct portions of an input device to perform related operations enables the user to perform detailed tasks that require two or more inputs, for example, by automatically updating a texture that was copied to other portions of the three-dimensional environment to a new texture indicated by placement of a portion of the input device, which reduces the number of inputs required to update all of copied textures to the newly selected texture, without displaying additional controls.

In some embodiments, performing the one or more operations based on the sequence of one or more inputs includes resizing an object (e.g., a currently selected object of the one or more virtual objects displayed in the three-dimensional environment) in accordance with a change in distance between the first portion of the input device and the second portion of the input device. For example, detecting the sequence of the one or more inputs comprises detecting both portions of the input device moving away or towards one another, and in response to detecting both portions of the input device moving away or towards one another, the computer system resizes an object in accordance with the speed of the movement and/or distance between the portions of the input device, as described with reference to FIG. 7G (e.g., moving the first portion 7024-1 and the second portion 7024-2 of the input device relative to each other causes the object 7104 to be resized). Using information acquired from two distinct portions of an input device to perform a single operation enables the user to perform detailed tasks that require inputs relative to each other, and reduces the number of inputs needed to perform the operation, such as changing a size of an object based on the two portions getting closer together or farther apart, without displaying additional controls.

In some embodiments, the input device includes an affordance coupled to a respective portion of the input device (e.g., the first portion 7024-1 and/or the second portion 7024-2 in FIGS. 7A-7N). In some embodiments, the affordance is a physical button or other sensor (e.g., pressure sensor, light sensor, magnetic sensor, or other touch-sensitive surface). In some embodiments, the affordance is in the first portion of the input device (e.g., first portion 7024-1), where the first portion of the input device is used to select or mark an object or a texture, to which an operation is to be performed on, as described, for example, with reference to FIGS. 7E (e.g., FIGS. 7E1-7E3), 7G, 7H, 7I, and 7K. For example, in FIGS. 7E (e.g., FIGS. 7E1-7E3) and 7G, by activating an affordance in the first portion 7024-1 and tapping on object 7104, the object 7104 is picked up by the first portion 7024-1 for subsequent movement and rotation in FIGS. 7F and 7H. In another example, in FIG. 7I, by activating an affordance in the first portion 7024-1 and tapping at a location in the three-dimensional environment, a virtual object 7105 is added to the three-dimensional environment at the location. In another example, in FIG. 7K, by activating an affordance in the first portion 7024-1 and placing the first portion 7024-1 at a position that corresponds to texture 7108, the texture 7108 is selected and copied for subsequent application to other areas in the three-dimensional environment. In some embodiments, the affordance in the second portion of the input device (e.g., second portion 7024-2), where the second portion of the input device is used to select or mark an object or a texture, to which an operation is to be performed on (e.g., in the manner analogous to those described with respect to the first portion, and/or where the roles of the first and second portions are reversed). In an example, in FIG. 7K-7M, by activating an affordance in the second portion 7024-2 of the input device and tapping at a position in the three-dimensional environment, a currently selected object or text (e.g., object 7107 or texture 7108 in FIG. 7K, texture 7111 in FIG. 7L) is pasted or applied to the position selected by the second portion 7024-2 of the input device (e.g., pasted object at area 7110 in FIG. 7L or pasted texture at area 7112 in FIG. 7M). In some embodiments, in response to detecting activation of the affordance (e.g., pressing the button or tapping on the sensor), the computer system changes a selection state of an object (e.g., to pick up and/or to release the object) that is located at a position in the three-dimensional environment corresponding to a current location of the respective portion of the input device. For example, the position of the respective portion of the input device when the button in the respective portion of the input device is selected or tapped indicates an object or texture to which to perform an operation. In some embodiments, the object or texture is indicated by the position of the respective portion of the input device at the time the input device is initially selected, such that the user does not need to hold the affordance down. Providing a button on a portion of the physical input device enables the user to select additional control options using the button, without displaying additional controls.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve user input for XR experiences. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve user input for XR experiences. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

What is claimed is:

1. A method, comprising:
at a computer system that is in communication with one or more cameras, a display generation component, and an input device, wherein the input device includes a first portion of the input device and a second portion of the input device that are physically coupled in a first configuration and physically decoupled in a second configuration:
displaying, via the display generation component, a three-dimensional environment that corresponds to a physical environment surrounding the input device, wherein displaying the three-dimensional environment includes displaying one or more virtual objects in the three-dimensional environment;
while displaying the three-dimensional environment, detecting, via the input device while the first portion of the input device is coupled to the second portion of the input device in the first configuration, a first input;
in response to detecting the first input while the first portion of the input device is coupled to the second portion of the input device in the first configuration, performing a first operation in the three-dimensional environment;
while the first portion of the input device and the second portion of the input device are decoupled in the second configuration, detecting a sequence of one or more inputs that includes movement of the first portion of the input device relative to the second portion of the input device; and
in response to detecting the sequence of one or more inputs, performing one or more operations based on the sequence of one or more inputs that includes the movement of the first portion of the input device relative to the second portion of the input device, wherein the one or more operations are different from the first operation.

2. The method of claim 1, further comprising, after performing the first operation, detecting that the input device has separated into the first portion of the input device and the second portion of the input device.

3. The method of claim 1, wherein:
performing the first operation includes performing a drag operation on a first object of the one or more virtual objects in the three-dimensional environment; and
performing the one or more operations based on the one or more inputs that includes the movement of the first portion of the input device relative to the second portion of the input device includes:
performing a second operation that changes an orientation of the first object relative to a current viewpoint of the user, and
performing a third operation that modifies the first object.

4. The method of claim 1, wherein performing the one or more operations based on the sequence of one or more inputs includes:
performing a fourth operation with respect to a second object of the one or more virtual objects displayed in the three-dimensional environment; and
performing a fifth operation with respect to the second object, the fifth operation being distinct from the fourth operation.

5. The method of claim 4, wherein:
performing the fourth operation includes changing a position of the second object relative to a current viewpoint of the user; and
performing the fifth operation includes modifying one or more visual properties of the second object.

6. The method of claim 1, wherein performing the one or more operations based on the sequence of one or more inputs includes:
performing a sixth operation that adds a third object to a portion of the three-dimensional environment; and
performing a seventh operation that removes the third object from the portion of the three-dimensional environment.

7. The method of claim 1, wherein performing the one or more operations based on the sequence of one or more inputs includes:
performing a single operation based on a respective input received from the first portion of the input device and a respective input received from the second portion of the input device.

8. The method of claim 7, wherein performing the single operation based on the respective input received from the first portion of the input device and the respective input received from the second portion of the input device includes:
rotating a fourth object of the one or more virtual objects in the three-dimensional environment relative to a pivot point in the three-dimensional environment in accordance with movement of the first portion of the input device, wherein the pivot point is selected based on a position of the second portion of the input device in the three-dimensional environment.

9. The method of claim 1, wherein detecting the sequence of one or more inputs includes:
detecting placement of the second portion of the input device in the three-dimensional environment; and
in accordance with a determination that the placement of the second portion of the input device meets preset criteria, using a location of the second portion of the input device as a basis for determining a viewpoint from which to generate a view of the three-dimensional environment.

10. The method of claim 1, including:
before detecting the sequence of one or more inputs, detecting that the input device transitions from the first configuration to the second configuration, including, detecting that the first portion of the input device is physically separated from contact with the second portion of the input device.

11. The method of claim 1, wherein:
detecting the sequence of the one or more inputs includes detecting a selection input, and detecting a drag input after detecting the selection input; and
performing the one or more operations based on the sequence of one or more inputs includes:
in response to detecting the selection input, performing a copy operation that copies a portion of the three-dimensional environment corresponding to a position of the selection input; and
in response to detecting the drag input after detecting the selection input, displaying a copy of the portion of the three-dimensional environment in one or more additional portions of the three-dimensional environment in accordance with the drag input.

12. The method of claim 1, wherein:
detecting the sequence of the one or more inputs includes:
detecting placement of the second portion of the input device on a surface corresponding to a fifth virtual object of the one or more virtual objects in the three-dimensional environment; and
while the second portion of the input device is placed on the surface corresponding to the fifth virtual object of the one or more virtual objects in the three-dimensional environment, detecting rotation of the second portion of the input device around an internal pivot point of the second portion of the input device, and
performing the one or more operations based on the sequence of one or more inputs includes rotating the fifth object relative to an internal pivot point of the fifth virtual object in accordance with corresponding to the rotation of the second portion of the input device.

13. The method of claim 1, wherein:
detecting the sequence of the one or more inputs includes:
detecting placement of the first portion of the input device on a surface corresponding to a sixth virtual object of the one or more virtual objects in the three-dimensional environment, and
while the first portion of the input device is placed on the surface corresponding to the sixth virtual object of the one or more virtual objects in the three-dimensional environment, detecting rotation of the second portion of the input device around an internal pivot point of the second portion of the input device, and
performing the one or more operations based on the sequence of one or more inputs includes rotating the sixth object relative to an internal pivot point of the sixth virtual object in accordance with the rotation of the second portion of the input device.

14. The method of claim 1, wherein:
detecting the sequence of the one or more inputs includes:
detecting placement of the first portion of the input device at a first location that corresponds to a first texture in the three-dimensional environment, and
while the first portion of the input device is placed at the first location, detecting placement of the second portion of the input device at a second location in the three-dimensional environment, and
performing the one or more operations based on the sequence of one or more inputs includes:
copying the first texture corresponding to the first location in the three-dimensional environment; and
displaying the copied first texture at the second location in the three-dimensional environment.

15. The method of claim 14, further comprising:
detecting movement of the first portion of the input device from the first location and placement of the first portion of the input device at a third location that corresponds to a second texture in the three-dimensional environment; and
in response to detecting placement of the first portion of the input device at the third location that corresponds to the second texture in the three-dimensional environment:
copying the second texture corresponding to the third location in the three-dimensional environment; and
displaying the copied second texture at one or more locations indicated by the second portion of the input device in the three-dimensional environment.

16. The method of claim 1, wherein performing the one or more operations based on the sequence of one or more inputs includes:
resizing an object in accordance with a change in distance between the first portion of the input device and the second portion of the input device.

17. The method of claim 1, wherein:
the input device includes an affordance coupled to a respective portion of the input device; and
in response to detecting activation of the affordance, changing a selection state of an object that is located at a position in the three-dimensional environment corresponding to a current location of the respective portion of the input device.

18. A non-transitory computer-readable storage medium storing one or more programs configured to be executed by one or more processors of a computer system that is in communication with a display generation component and an input device, wherein the input device includes a first portion of the input device and a second portion of the input device that are physically coupled in a first configuration and physically decoupled in a second configuration, the one or more programs including instructions for:
displaying, via the display generation component, a three-dimensional environment that corresponds to a physical environment surrounding the input device, wherein displaying the three-dimensional environment includes displaying one or more virtual objects in the three-dimensional environment;
while displaying the three-dimensional environment, detecting, via the input device while the first portion of the input device is coupled to the second portion of the input device in the first configuration, a first input;
in response to detecting the first input while the first portion of the input device is coupled to the second portion of the input device in the first configuration, performing a first operation in the three-dimensional environment;
while the first portion of the input device and the second portion of the input device are decoupled in the second configuration, detecting a sequence of one or more inputs that includes movement of the first portion of the input device relative to the second portion of the input device;
in response to detecting the sequence of one or more inputs, performing one or more operations based on the sequence of one or more inputs that includes the movement of the first portion of the input device relative to the second portion of the input device, wherein the one or more operations are different from the first operation.

19. A computer system that is in communication with a display generation component and an input device, wherein the input device includes a first portion of the input device and a second portion of the input device that are physically coupled in a first configuration and physically decoupled in a second configuration, the computer system comprising:
one or more processors; and
memory storing one or more programs configured to be executed by the one or more processors, the one or more programs including instructions for:
displaying, via the display generation component, a three-dimensional environment that corresponds to a physical environment surrounding the input device, wherein displaying the three-dimensional environment includes displaying one or more virtual objects in the three-dimensional environment;
while displaying the three-dimensional environment, detecting, via the input device while the first portion of the input device is coupled to the second portion of the input device in the first configuration, a first input;
in response to detecting the first input while the first portion of the input device is coupled to the second portion of the input device in the first configuration, performing a first operation in the three-dimensional environment;
while the first portion of the input device and the second portion of the input device are decoupled in the second configuration, detecting a sequence of one or more inputs that includes movement of the first portion of the input device relative to the second portion of the input device; and
in response to detecting the sequence of one or more inputs, performing one or more operations based on the sequence of one or more inputs that includes the movement of the first portion of the input device relative to the second portion of the input device, wherein the one or more operations are different from the first operation.
